(19) United States
(12) Patent Application Publication
(10) Pub. No.: US 2025/0376589 A1
(43) Pub. Date: Dec. 11, 2025

(54) RESIN COMPOSITION AND ARTICLE MADE THEREFROM

(71) Applicant: Elite Electronic Material (KunShan) Co., Ltd., Kunshan City (CN)

(72) Inventors: Wentao XUE, Kunshan City (CN); Zhenfang SHANG, Kunshan City (CN); Rongtao WANG, Kunshan City (CN); Yiqiang GE, Kunshan City (CN)

(21) Appl. No.: 18/770,003

(22) Filed: Jul. 11, 2024

(30) Foreign Application Priority Data
Jun. 7, 2024 (CN) 2024107364623

(51) Int. Cl. C08L 71/12; C08K 5/01; C08K 5/3415; C08K 5/3435; C08K 5/524; C08K 7/18

(52) U.S. Cl. CPC C08L 71/12; C08K 5/01; C08K 5/3415; C08K 5/3435; C08K 5/524; C08K 7/18

(57) ABSTRACT

A resin composition includes 100 parts by weight of an unsaturated C═C double bond-containing polyphenylene ether resin, 10 parts by weight to 80 parts by weight of a compound of Formula (1) and 1 part by weight to 20 parts by weight of a compound of Formula (2). Moreover, also provided is an article made from the resin composition described above, which comprises a prepreg, a resin film, a laminate or a printed circuit board, wherein the article achieves improvement in at least one of the following properties including: ratio of loss modulus to storage modulus, percent of thermal expansion in Z-axis, temperature coefficient of dielectric constant, temperature coefficient of dissipation factor and passive intermodulation.

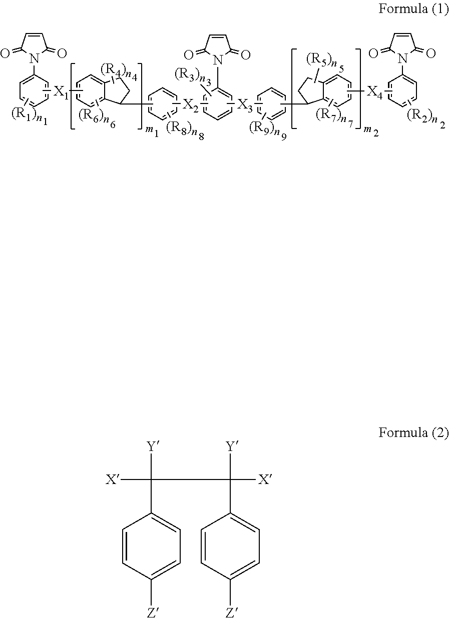

### CROSS-REFERENCE TO RELATED APPLICATION

This application claims the priority benefits of China Patent Application No. 2024107364623, filed on Jun. 7, 2024. The entirety of the above-mentioned patent application is hereby incorporated by reference herein and made a part of this specification.

### BACKGROUND

### 1. Field of the Disclosure

The present disclosure mainly relates to a resin composition and an article made therefrom, more particularly to a resin composition useful for preparing a prepreg, a resin film, a laminate (e.g., a copper-clad laminate) and a printed circuit board, and an article made therefrom.

### 2. Description of Related Art

Printed circuit board (PCB), as a basic electronic component, is widely used in many fields such as mobile phones, computers, mobile communication, data centers, automobiles, industrial control and medicine, aerospace, etc., the technical level thereof and reliability having direct impacts on performance and stability of electronic equipment. With the development of technologies such as mobile communication and AI, the transmission rate and frequency of signals have been greatly improved. Copper-clad laminate (CCL), as a laminate material of PCB, mainly plays the role of the interconnection and conduction, insulation and support for PCB, which has great influences on the transmission rate, energy loss and characteristic impedance of signals in circuits. The properties of PCB, such as performance, quality, processability, reliability, stability, etc., depend on the performance and quality of copper-clad laminates to a large extent.

The current problems of process capability, signal integrity, heat dissipation and stress are faced by advanced PCB packaging technology, presenting more challenges to the performance of copper-clad laminates, such as at least one of lower passive intermodulation (PIM), lower ratio of loss modulus to storage modulus, lower percent of thermal expansion in Z-axis, lower temperature coefficient of dielectric constant and lower temperature coefficient of dissipation factor. However, the current copper-clad laminates and the resin compositions used thereof still mainly focus on the general characteristics of copper-clad laminates and fail to fully satisfy the higher demands in the properties of printed circuit boards.

Accordingly, there is an urgent need to develop a resin composition and an article such as a copper-clad laminate made therefrom that meet one, more or all of the properties including lower passive intermodulation, lower ratio of loss modulus to storage modulus, lower percent of thermal expansion in Z-axis, lower temperature coefficient of dielectric constant and lower temperature coefficient of dissipation factor.

### SUMMARY

To overcome the problems facing prior arts, particularly one or more of the above-mentioned technical problems of conventional materials, it is a primary object of the present disclosure to provide a resin composition and an article made therefrom which may overcome at least one of the above-mentioned technical problems.

In one aspect, the present disclosure provides a resin composition, which comprises:
(A) 100 parts by weight of an unsaturated C═C double bond-containing polyphenylene ether resin;
(B) 10 parts by weight to 80 parts by weight of a compound of Formula (1); and
(C) 1 part by weight to 20 parts by weight of a compound of Formula (2);

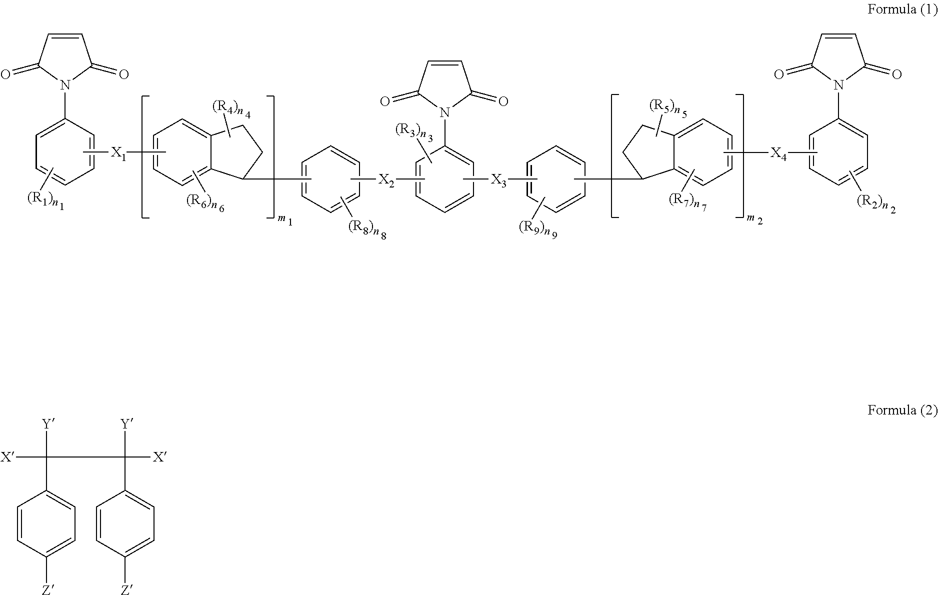

wherein:
in Formula (1), R₁ to R₉ each independently represent a C1 to C4 alkyl group; n1, n2, n8 and ng each independently represent an integer of 0 to 4; n₄ and n₅ each independently represent an integer of 0 to 5; n_{3,} n₆ and n₇ each independently represent an integer of 0 to 3; m₁ and m₂ each independently represent average number of repeating units, m₁ is a value of 0 to 20, m₂ is a value of 0 to 20, and m₁+m₂=0.5 to 20; and X₁, X₂, X₃ and X₄ each independently represent a C1 to C4 divalent alkyl group; and
in Formula (2), each X′, Y′ and Z′ independently represent a C1 to C4 alkyl group, a phenyl group, a hydrogen atom or an unsaturated C═C double bond-containing group.

For example, in one embodiment, the unsaturated C═C double bond-containing polyphenylene ether resin comprises any one of a vinylbenzyl group-containing polyphenylene ether resin, a (meth) acryloyl group-containing polyphenylene ether resin and a vinyl group-containing polyphenylene ether resin or a combination thereof.

For example, in one embodiment, the compound of Formula (1) comprises a compound of Formula (1-1):

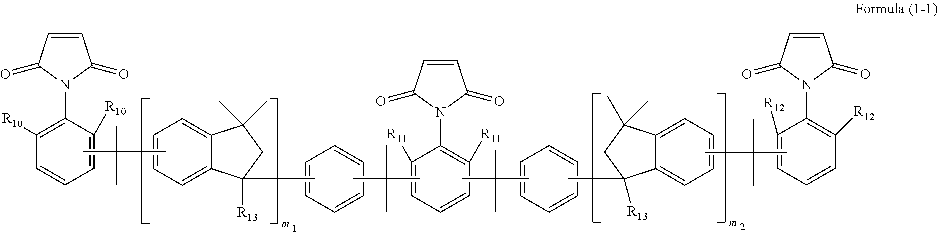

wherein, R₁₀, R₁₁, R₁₂ and R₁₃ each independently represent a hydrogen atom or a C1 to C4 alkyl group, m1 and m2 each independently represent average number of repeating units, m1 is a value from 0 to 20, m₂ is a value from 0 to 20, and m₁+m₂=0.5 to 20. For example, in one embodiment, the compound of Formula (1) comprises any

one of a compound of Formula (1-2), a compound of Formula (1-3), a compound of Formula (1-4), a compound of Formula (1-5), a compound of Formula (1-6), a compound of Formula (1-7) and a compound of Formula (1-8) or a combination thereof:

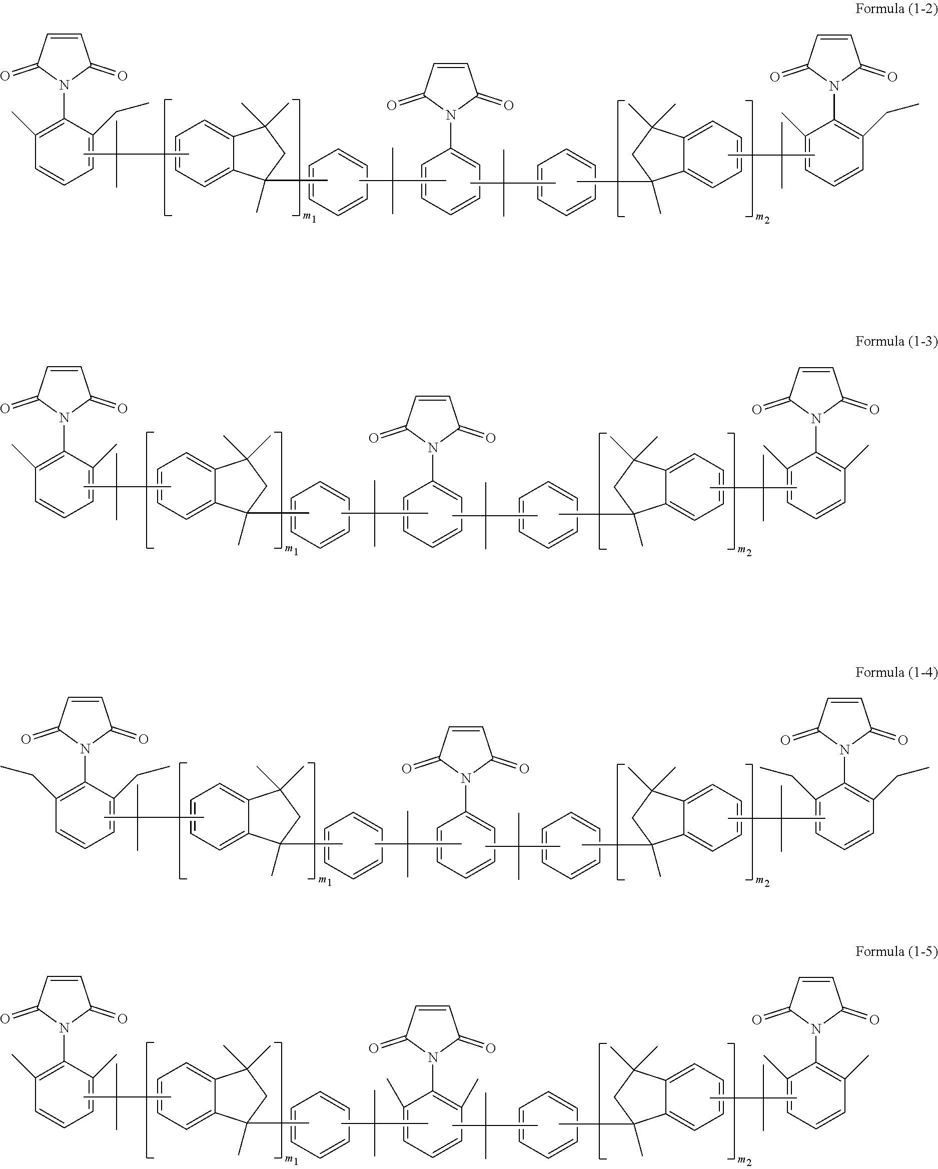

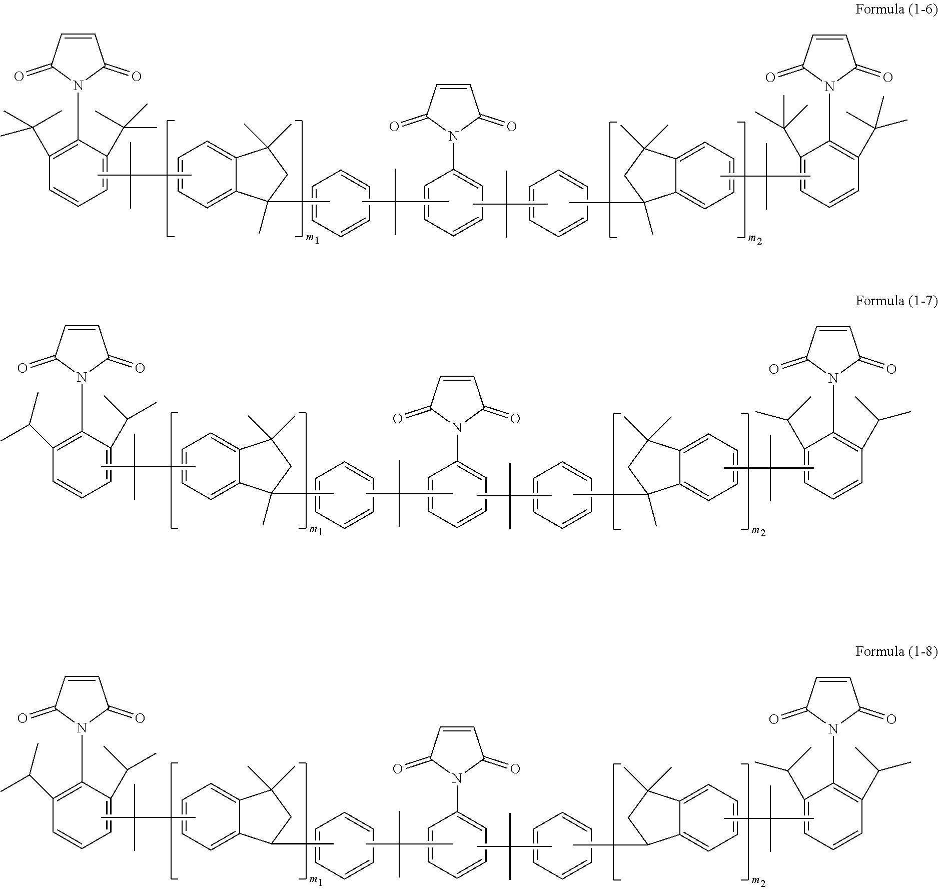

in Formula (1-2) to Formula (1-8), m1 and m2 each independently represent average number of repeating units, m1 is a value from 0 to 20, m₂ is a value from 0 to 20, and m₁+m₂=0.5 to 20.

Each compound of Formula (1) according to the present disclosure contains an indane skeleton and three maleimide groups, wherein the indane skeleton has a low dielectric constant and an excellent dielectric stability, and the three maleimide groups are reactive functional groups which may perform self-polymerization under heat and may also perform free radical polymerization with other components containing an unsaturated bond in the resin composition and finally result in crosslinking and curing. The cured product has lower passive intermodulation.

For example, in one embodiment, the compound of Formula (2) has at least one unsaturated C═C double bond-containing group.

For example, in one embodiment, the compound of Formula (2) comprises any one of a compound of Formula (2-1) to a compound of Formula (2-6) or a combination thereof:

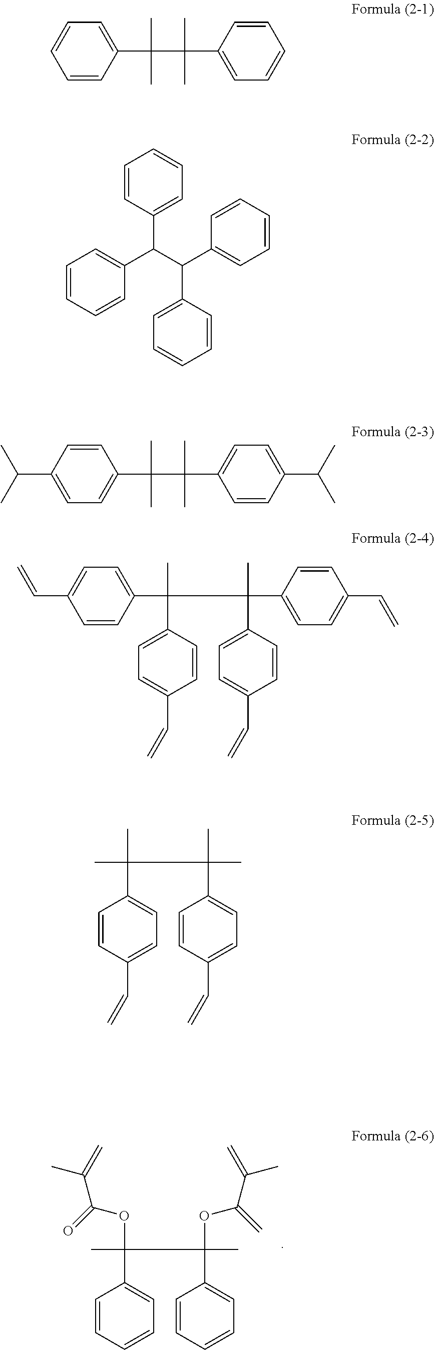

For example, in one embodiment, the resin composition further comprises 0.001 part by weight to 0.8 part by weight of any one of a compound of Formula (3), a 10 compound of Formula (4) and a compound of Formula (5) or a combination thereof:

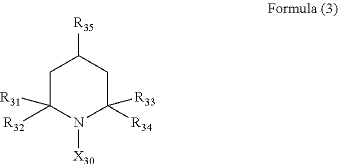

in Formula (3), X₃₀ is an oxygen radical or a hydroxyl group; R₃₁ to R₃₄ are independently a hydrogen atom or a C1 to C4 alkyl group, and R₃₁ to R₃₄ are not a hydrogen atom at the same time; and R₃₅ is a hydrogen atom, a methyl group, an amino group, a hydroxyl group, a carbonyl group or a carboxyl group;

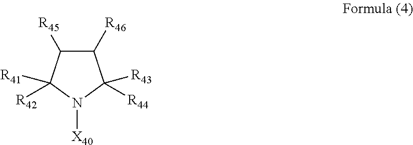

in Formula (4), X₄₀ is an oxygen radical or a hydroxyl group; R₄₁ to R₄₄ are independently a hydrogen atom or a C1 to C4 alkyl group, and R₄₁ to R₄₄ are not a hydrogen atom at the same time; R₄₅ and R₄₆ are independently a hydrogen atom, a methyl group, an amino group, a hydroxyl group, a carbonyl group or a carboxyl group, or R₄₅ and R₄₆ together define a benzene ring structure;

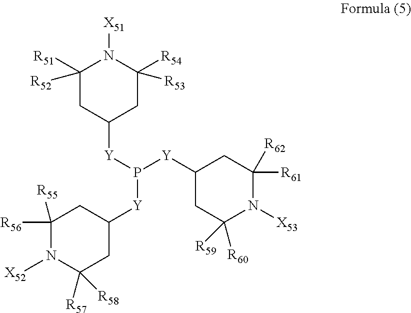

in Formula (5), P is a phosphorus atom, X₅₁ to X₅₃ each independently is an oxygen radical or a hydroxyl group; Y is an oxygen atom or a phenylene group; R₅₁ to R₆₂ are 5 independently a hydrogen atom or a Cl to C4 alkyl group, and R₅₁ to R₆₂ are not a hydrogen atom at the same time.

For example, in one embodiment, the compound of Formula (3) comprises any one of a compound of Formula (3-1), a compound of Formula (3-2), a compound of Formula (3-3), a compound of Formula (3-4) and a compound of Formula (3-5) or a 10 combination thereof, the compound of Formula (4) comprises any one of a compound of Formula (4-1), a compound of Formula (4-2), a compound of Formula (4-3) and a compound of Formula (4-4) or a combination thereof, and the compound of Formula (5) comprises any one of a compound of Formula (5-1), a compound of Formula (5-2) and a compound of Formula (5-3) or a combination thereof:

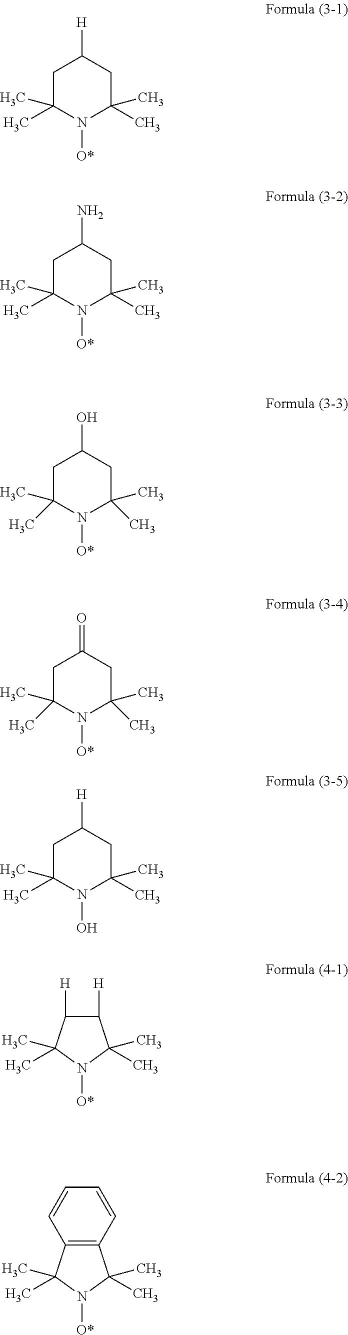

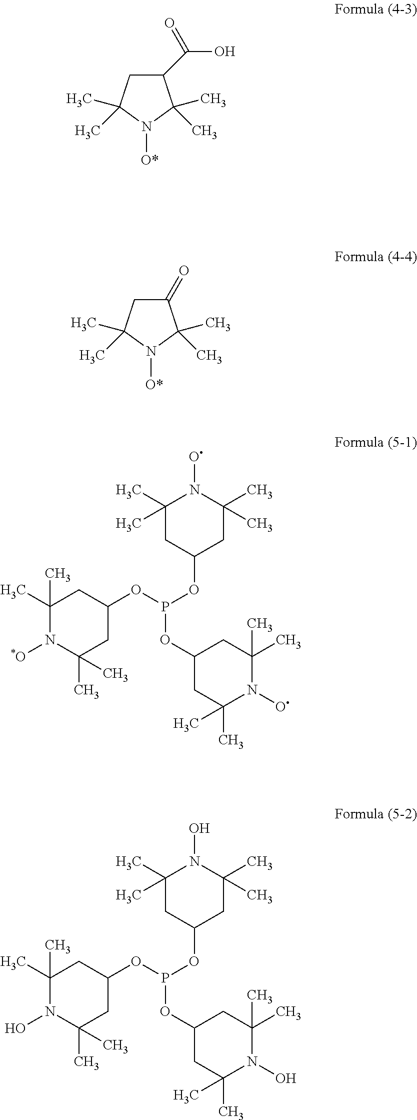

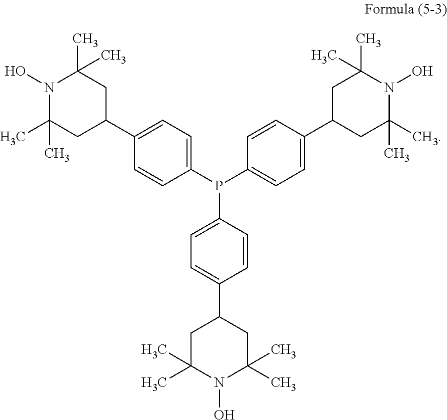 [SMILES: CC1(C)CC(c2ccc(P(c3ccc(C4CC(C)(C)N(O)C(C)(C)C4)cc3)c3ccc(C4CC(C)(C)N(O)C(C)(C)C4)cc3)cc2)CC(C)(C)N1O]

For example, in one embodiment, the resin composition further comprises 5 parts by weight to 25 parts by weight of an unsaturated C═C double bond-containing crosslinking agent, 20 parts by weight to 80 parts by weight of a polyolefin or a combination thereof.

For example, in one embodiment, the resin composition further comprises any one of a benzoxazine resin, an epoxy resin, a polyester resin, a phenol resin, an amine curing agent, a polyamide, a polyimide, a styrene maleic anhydride, a maleimide resin different from the compound of Formula (1), a cyanate ester and a maleimide triazine resin or a combination thereof.

For example, in one embodiment, the resin composition further comprises any one of an inorganic filler, a flame retardant, a curing accelerator different from the compound of Formula (2), a solvent, a silane coupling agent, a coloring agent and a toughening agent or a combination thereof.

In another aspect, to achieve the above-mentioned objects, the present disclosure further provides an article made from the aforesaid resin composition, including a prepreg, a resin film, a laminate or a printed circuit board.

For example, in one embodiment, the article described above has at least one, more or all of the following properties:
a ratio of loss modulus to storage modulus as measured by reference to IPC-TM-650 2.4.24.4 of less than or equal to 0.07;
a percent of thermal expansion in Z-axis as measured by reference to IPC-TM-650 2.4.24.5 of less than or equal to 1.5%;
a temperature coefficient of dielectric constant as measured by reference to IPC-TM-650 2.5.5.13 of less than or equal to 12.0 ppm/° C.;
a temperature coefficient of dissipation factor as measured by reference to IPC-TM-650 2.5.5.13 of less than or equal to 3400 ppm/° C.; and
a passive intermodulation as measured by reference to IEC-62037 of less than or equal to-162.0 dBc.

### DESCRIPTION OF THE EMBODIMENTS

To enable those skilled in the art to further appreciate the features and effects of the present disclosure, words and terms contained in the specification and appended claims are described and defined. Unless otherwise defined, all technical and scientific terms used herein have the same meaning as commonly understood by those of ordinary skill in the art to which this disclosure pertains. In the case of conflict, the present document and definitions contained herein will control.

While some theories or mechanisms may be proposed herein, the present disclosure is not bound by any theories or mechanisms described regardless of whether they are right or wrong, as long as the embodiments can be implemented according to the present disclosure.

As used herein, “a,” “an” or any similar expression is employed to describe components and features of the present disclosure. This is done merely for convenience and to give a general sense of the scope of the present disclosure. Accordingly, this description should be read to include one or at least one and the singular also includes the plural unless it is obvious to mean otherwise.

As used herein, the term “encompasses,” “encompassing,” “comprises,” “comprising,” “includes,” “including,” “has,” “having” or any other variant thereof is construed as an open-ended transitional phrase intended to cover a non-exclusive inclusion. For example, a composition comprising a list of elements or an article made therefrom encompasses any one or any type of the listed elements and is not necessarily limited to only those elements listed herein, but may also include other elements not expressly listed or inherent to such composition or article. Further, unless expressly stated to the contrary, the term “or” refers to an inclusive or and not to an exclusive or. For example, a condition “A or B” is satisfied by any one of the following: A is true (or present) and B is false (or not present), A is false (or not present) and B is true (or present), and both A and B are true (or present). In addition, whenever open-ended transitional phrases are used, such as “encompasses,” “encompassing,” “comprises,” “comprising,” “includes,” “including,” “has,” “having” or any other variant thereof, it is understood that close-ended transitional phrases such as “consisting of,” “composed by” and “remainder being” and partially open-ended transitional phrases such as “consisting essentially of,” “primarily consisting of,” “mainly consisting of,” “primarily containing,” “composed essentially of,” “essentially having,” etc. are also disclosed and included.

As used herein, “or a combination thereof” means “or any combination thereof” encompasses any combination of two or more of the listed elements, and “any” means “any one”, vice versa. For example, “a composition or an article made therefrom includes A, B, C or a combination thereof” or “a composition or an article made therefrom includes any one of A, B and C or a combination thereof” is construed to encompass the following situations: A is true (or present), and B and C are false (or not present); B is true (or present), and A and C are false (or not present); C is true (or present), and A and B are false (or not present); A and B are true (or present), and C is false (or not present); A and C are true (or present), and B is false (or not present); B and C are true (or present), and A is false (or not present); A, B and C are all true (or present), and other elements not expressly listed but inherent to such composition or article.

As used herein, the term “and” or any other variant thereof is used to connect parallel sentence components, and there is no distinction between the front and rear components. The meaning of the parallel sentence components does not change in the grammatical sense after the position is exchanged.

In this disclosure, features and conditions such as values, numbers, contents, amounts or concentrations are presented as a numerical range or a percentage range merely for convenience and brevity. Therefore, a numerical range or a percentage range should be interpreted as encompassing and specifically disclosing all possible subranges and individual numerals or values therein, including integers and fractions, particularly all integers therein. For example, a range of “1.0 to 8.0” or “between 1.0 and 8.0” should be understood as explicitly disclosing all subranges such as 1.0 to 8.0, 1.0 to 7.0, 2.0 to 8.0, 2.0 to 6.0, 3.0 to 6.0, 4.0 to 8.0, 3.0 to 8.0 and so on and encompassing the endpoint values, particularly subranges defined by integers, as well as disclosing all individual values in the range such as 1.0, 2.0, 3.0, 4.0, 5.0, 6.0, 7.0 and 8.0. Unless otherwise defined, the aforesaid interpretation rule should be applied throughout the present disclosure regardless of broadness of the scope.

Whenever amount, concentration or other numeral or parameter is expressed as a range, a preferred range or a series of upper and lower limits, it is understood that all ranges defined by any pair of the upper limit or preferred value and the lower limit or preferred value are specifically disclosed, regardless whether these ranges are explicitly described or not. In addition, unless otherwise defined, whenever a range is mentioned, the range should be interpreted as inclusive of the endpoints and every integers and fractions in the range.

Given the intended purposes and advantages of this disclosure are achieved, numerals or figures have the precision of their significant digits. For example, 40.0 should be understood as covering a range of 39.50 to 40.49.

As used herein, a Markush group or a list of items is used to describe examples or embodiments of the present disclosure. A skilled artisan will appreciate that all subgroups of members or items and individual members or items of the Markush group or list can also be used to describe the present disclosure. For example, when X is described as being “selected from a group consisting of X₁, X₂ and X₃, ” it is intended to disclose the situations of X is X₁ and X is X₁ and/or X₂ and/or X₃. In addition, when a Markush group or a list of items is used to describe examples or embodiments of the present disclosure, a skilled artisan will understand that any subgroup or any combination of the members or items in the Markush group or list may also be used to describe the present disclosure. Therefore, for example, when X is described as being “selected from a group consisting of X₁, X₂ and X₃” and Y is described as being “selected from a group consisting of Y₁, Y₂ and Y₃, ” the disclosure encompasses any combination of X is X₁ and/or X₂ and/or X₃ and Y is Y₁ and/or Y₂ and/or Y₃.

Unless otherwise specified, according to the present disclosure, a compound refers to a chemical substance formed by two or more elements bonded with chemical bonds and may comprise a small molecule compound and a polymer compound, but not limited thereto. Any compound disclosed herein is interpreted to not only include a single chemical substance but also include a class of chemical substances having the same kind of components or having the same property.

Unless otherwise specified, according to the present disclosure, a polymer refers to the product formed by monomer(s) via polymerization and usually comprises multiple aggregates of polymers respectively formed by multiple repeated simple structure units by covalent bonds; the monomer refers to the compound forming the polymer. A polymer may comprise a homopolymer, a copolymer, a prepolymer, etc., but not limited thereto. A homopolymer refers to the polymer formed by the polymerization of one monomer. A copolymer refers to the polymer formed by the polymerization of two or more types of monomers. Copolymers comprise: random copolymers, such as a structure of -AABABBBAAABBA-; alternating copolymers, such as a structure of -ABABABAB-; graft copolymers, such as a structure of -AA(A-BBBB)AA(A-BBBB)AAA-; and block copolymers, such as a structure of -AAAAA-BBBBBB-AAAAA-. For example, a styrene-butadiene copolymer disclosed herein is interpreted as comprising a styrene-butadiene random copolymer, a styrene-butadiene alternating copolymer, a styrene-butadiene graft copolymer or a styrene-butadiene block copolymer. A prepolymer refers to a polymer having a lower molecular weight between the molecular weight of monomer and the molecular weight of final polymer, and a prepolymer contains a reactive functional group capable of participating further polymerization to obtain the final polymer product which has been fully crosslinked or cured. The term “polymer” includes but is not limited to an oligomer. An oligomer refers to a polymer with 2 to 20, typically 2 to 5, repeating units.

To those of ordinary skill in the art to which this disclosure pertains, a resin composition containing an additive and three compounds (e.g., A, B and C), a total of four components, is different from a resin composition containing the additive and a prepolymer formed by the three compounds (e.g., A, B and C), a total of two components, as they are completely different from each other in the aspects of preparation method, physical or chemical properties of the resin composition and properties of an article or product made therefrom. For example, the former involves mixing A, B, C and the additive to form the resin composition; in contrast, the latter involves first subjecting a mixture comprising A, B and C to a prepolymerization reaction at proper conditions to form a prepolymer and then mixing the prepolymer with the additive to form the resin composition. For example, to those of ordinary skill in the art to which this disclosure pertains, the two resin compositions have completely different compositions; in addition, because the prepolymer formed by A, B and C functions completely different from A, B and C individually or collectively in the resin composition, the two resin compositions should be construed as completely different chemical substances and have completely different chemical statuses. For example, to those of ordinary skill in the art to which this disclosure pertains, because the two resin compositions are completely different chemical substances, articles made therefrom will not have the same properties. For example, to a resin composition containing a crosslinking agent and a prepolymer formed by A, B and

C, since A, B and C have been partially reacted or converted during the prepolymerization reaction to form the prepolymer, during the process of heating to semi-cure the resin composition at a high temperature condition, a partial crosslinking reaction occurs between the prepolymer and the crosslinking agent but not between A, B and C individually and the crosslinking agent. As such, articles made from the two resin compositions will be completely different and have completely different properties.

Unless otherwise specified, the term “resin” of the present disclosure is a widely used common name of a synthetic polymer and is construed as comprising monomer and its combination, polymer and its combination or a combination of monomer and its polymer, but not limited thereto.

Unless otherwise specified, according to the present disclosure, a modification comprises a product derived from a resin with its reactive functional group modified, a product derived from a prepolymerization reaction of a resin and other resins, a product derived from a crosslinking reaction of a resin and other resins, a product derived from copolymerizing a resin and other resins, etc.

The unsaturated bond described herein, unless otherwise specified, refers to a reactive unsaturated bond, such as but not limited to an unsaturated double bond with the potential of being crosslinked with other functional groups, such as an unsaturated C═C double bond with the potential of being crosslinked with other functional groups, but not limited thereto.

The unsaturated C═C double bond as used herein preferably comprises, but not limited to, a vinyl group, a vinylbenzyl group, a (meth) acryloyl group, an allyl group or a combination thereof. The term “vinyl group” is construed as comprising a vinyl group and a vinylene group, and the term “(meth) acryloyl group” is construed as comprising an acryloyl group and a methacryloyl group.

Unless otherwise specified, the alkyl group, the alkenyl group and the monomer described herein are construed to encompass various isomers thereof. For example, a propyl group is construed to encompass n-propyl and iso-propyl.

Unless otherwise specified, as used herein, part(s) by weight represents weight part(s) in any weight unit in the resin composition, such as but not limited to kilogram, gram, pound and so on. For example, 100 parts by weight of an unsaturated C═C double bond-containing polyphenylene ether resin may represent 100 kilograms of the unsaturated C═C double bond-containing polyphenylene ether resin or 100 pounds of the unsaturated C═C double bond-containing polyphenylene ether resin.

Unless otherwise specified, in the present disclosure, wt % represents weight (or mass) percentage.

It should be understood that all features disclosed herein may be combined in any way to constitute the technical solution of the present disclosure, as long as there is no conflict present in the combination of these features.

Examples and embodiments are described in detail below. It will be understood that these examples and embodiments are exemplary only and are not intended to limit the scope and use of the present disclosure. Unless otherwise specified, processes, reagents and conditions described in the examples are those known in the art.

As described above, the present disclosure provides a resin composition, comprising the following components:
(A) 100 parts by weight of an unsaturated C═C double bond-containing polyphenylene ether resin;
(B) 10 parts by weight to 80 parts by weight of a compound of Formula (1); and
(C) 1 part by weight to 20 parts by weight of a compound of Formula (2);

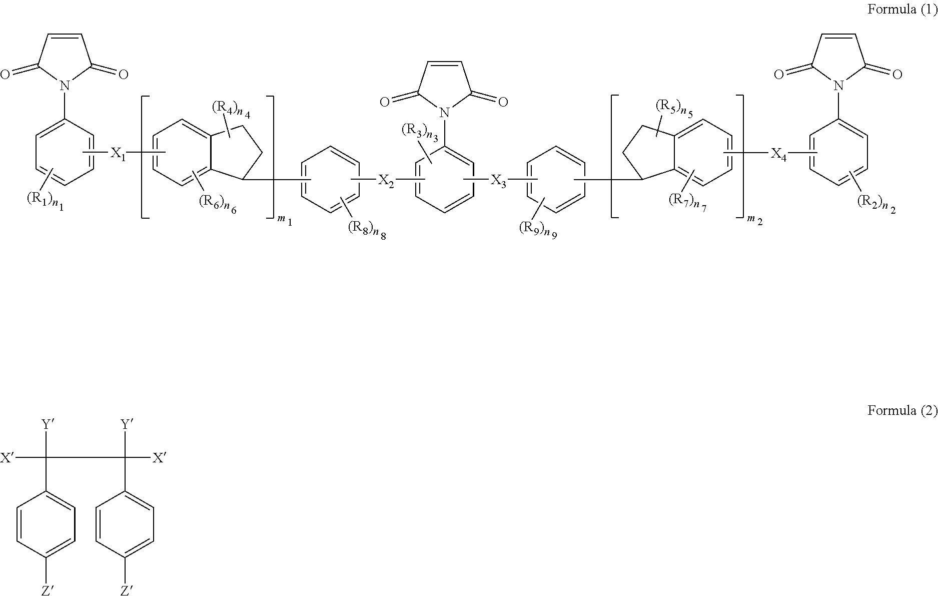

wherein:
in Formula (1), R₁ to R₉ each independently represent a C1 to C4 alkyl group (such as methyl, ethyl, propyl, butyl or an isomer thereof); n₁, n₂, n₈ and n₉ each independently represent an integer of 0 to 4 (such as 0, 1, 2, 3 or 4); n4 and n5 each independently represent an integer of 0 to 5 (such as 0, 1, 2, 3, 4 or 5); n3, n6 and n7 each independently represent an integer of 0 to 3 (such as 0, 1, 2 or 3); mi and m2 each independently represent average number of repeating units, m1 is a value of 0 to 20, m2 is a value of 0 to 20, and m₁+m₂=0.5 to 20 (such as 0.5, 1, 2, 3, 4, 5, 6, 7, 8, 9, 10, 11, 12, 13, 14, 15, 16, 17, 18, 19 or 20); and X₁, X₂, X₃ and X₄ each independently represent a C1 to C4 divalent alkyl group (such as methylene, ethylene, propylene or butylene or an isomer thereof); and
in Formula (2), X′, Y′ and Z′ each independently represent a C1 to C4 alkyl group (such as methyl, ethyl, propyl, butyl or an isomer thereof), a phenyl group, a hydrogen atom or an unsaturated C═C double bond-containing group (such as vinyl, allyl, styryl or (meth)acryloyloxy).

The unsaturated C═C double bond-containing polyphenylene ether resin suitable for the present disclosure is not particularly limited and may be any one or more unsaturated C═C double bond-containing polyphenylene ether resins useful for making a prepreg, a resin film, a laminate or a printed circuit board and may be any one or more commercial products, products prepared by the Applicant or a combination thereof, such as but not limited to any one of a vinylbenzyl group-containing polyphenylene ether resin, a (meth)acryloyl group-containing polyphenylene ether resin and a vinyl group-containing polyphenylene ether resin or a combination thereof.

The unsaturated C═C double bond-containing polyphenylene ether resin of the present disclosure has an unsaturated C═C double bond and a phenylene ether skeleton, wherein the unsaturated C═C double bond is a reactive group which may perform self-polymerization under heat and may also perform free radical polymerization with other components containing an unsaturated bond in the resin composition and finally result in crosslinking and curing. The cured product thereof has high heat resistance and good dielectric properties. Preferably, the unsaturated C═C double bond-containing polyphenylene ether resin comprises an unsaturated C═C double bond-containing polyphenylene ether resin with 2,6-dimethyl substitution in its phenylene ether skeleton, wherein the methyl groups form steric hindrance to prevent the oxygen atom of the ether group from forming a hydrogen bond or Van der Waals force to absorb moisture, thereby achieving better dielectric properties.

For example, in one embodiment, the unsaturated C═C double bond-containing polyphenylene ether resin comprises, but not limited to, a vinylbenzyl group-containing polyphenylene ether resin with a number average molecular weight of about 1200 (such as OPE-2st 1200, available from Mitsubishi Gas Chemical Co., Inc.), a vinylbenzyl group-containing polyphenylene ether resin with a number average molecular weight of about 2200 (such as OPE-2st 2200, available from Mitsubishi Gas Chemical Co., Inc.), a vinylbenzyl group-containing polyphenylene ether resin with a number average molecular weight of about 2400 to 2800 (such as a vinylbenzyl group-containing bisphenol A polyphenylene ether resin), a (meth)acryloyl group-containing polyphenylene ether resin with a number average molecular weight of about 1900 to 2300 (such as SA9000, available from Sabic), a vinyl group-containing polyphenylene ether resin with a number average molecular weight of about 2200 to 3000, or a combination thereof. The vinyl group-containing polyphenylene ether resin may include various polyphenylene ether resins disclosed in the US Patent Application Publication No. 20160185904A1, all of which are incorporated herein by reference in their entirety. For example, in one embodiment, the vinylbenzyl group-containing polyphenylene ether resin comprises, but not limited to, a vinylbenzyl group-containing biphenyl polyphenylene ether resin, a vinylbenzyl group-containing bisphenol A polyphenylene ether resin or a combination thereof.

Relative to 100 parts by weight of the unsaturated C═C double bond-containing polyphenylene ether resin, the resin composition according to the present disclosure further comprises 10 parts by weight to 80 parts by weight of a compound of Formula (1). For example, relative to 100 parts by weight of the unsaturated C═C double bond-containing polyphenylene ether resin, the resin composition according to the present disclosure may further comprise 10, 20, 30, 40, 50, 60, 70 or 80 parts by weight of a compound of Formula (1). For example, in one embodiment, the compound of Formula (1) is an indane-containing trimaleimide resin.

For example, in one embodiment, the compound of Formula (1) comprises a compound of Formula (1-1). The structure of the compound of Formula (1-1) is shown above, wherein R₁₀, R₁₁, R₁₂ and R₁₃ each independently represent a hydrogen atom or a

C1 to C4 alkyl group (such as methyl, ethyl, propyl, butyl or an isomer thereof), m1 and m2 each independently represent average number of repeating units, mis a value of 0 to 20, m2 is a value of 0 to 20, and m₁+m₂=0.5 to 20 (such as 0.5, 1, 2, 3, 4, 5, 6, 7, 8, 9, 10, 11, 12, 13, 14, 15, 16, 17, 18, 19 or 20).

For example, in one embodiment, the compound of Formula (1) comprises any one of a compound of Formula (1-2), a compound of Formula (1-3), a compound of Formula (1-4), a compound of Formula (1-5), a compound of Formula (1-6), a compound of Formula (1-7) and a compound of Formula (1-8) or a combination thereof. The structures of compound of Formula (1-2) to compound of Formula (1-8) are shown above, wherein m1 and m2 each independently represent average number of repeating units, mis a value of 0 to 20, m2 is a value of 0 to 20, and m1 +m2 =0.5 to 20 (such as 0.5, 1, 2, 3, 4, 5, 6, 7, 8, 9, 10, 11, 12, 13, 14, 15, 16, 17, 18, 19 or 20).

Relative to 100 parts by weight of the unsaturated C═C double bond-containing polyphenylene ether resin, the resin composition according to the present disclosure further comprises 1 part by weight to 20 parts by weight of a compound of Formula (2). For example, relative to 100 parts by weight of the unsaturated C═C double bond-containing polyphenylene ether resin, the resin composition according to the present disclosure may comprise 1, 2, 3, 4, 5, 6, 7, 8, 9, 10, 11, 12, 13, 14, 15, 16, 17, 18, 19 or 20 parts by weight of the compound of Formula (2). For example, in one embodiment, the compound of Formula (2) may serve as a curing accelerator of the resin composition of the present disclosure.

For example, in one embodiment, the compound of Formula (2) has an unsaturated C═C double bond-containing group. For example, in one embodiment, the compound of Formula (2) has a vinyl group, an allyl group, a styryl group or a (meth) acryloyloxy group, but not limited thereto.

For example, in one embodiment, the compound of Formula (2) comprises any one of a compound of Formula (2-1) to a compound of Formula (2-6) or a combination thereof, the structures of the compound of Formula (2-1) to the compound of Formula (2-6) being shown above.

In addition to the aforesaid unsaturated C═C double bond-containing polyphenylene ether resin, the compound of Formula (1) and the compound of Formula (2), the resin composition disclosed herein may also optionally comprise other components.

For example, in a preferred embodiment, the resin composition of the present disclosure further comprises any one of a compound of Formula (3), a compound of Formula (4) and a compound of Formula (5) or a combination thereof, the structures of the compound of Formula (3) to the compound of Formula (5) being shown above.

For example, in a preferred embodiment, relative to 100 parts by weight of the unsaturated C═C double bond-containing polyphenylene ether resin, the resin composition disclosed herein further comprises 0.001 part by weight to 0.8 part by weight of any one of a compound of Formula (3), a compound of Formula (4) and a compound of Formula (5) or a combination thereof. For example, the amount of any one of a compound of Formula (3), a compound of Formula (4) and a compound of Formula (5) or a combination thereof may be, but not limited to, 0.001 part by weight, 0.003 part by weight, 0.005 part by weight, 0.01 part by weight, 0.015 part by weight, 0.02 part by weight, 0.05 part by weight, 0.1 part by weight, 0.2 part by weight, 0.3 part by weight, 0.4 part by weight, 0.5 part by weight, 0.6 part by weight, 0.7 part by weight or 0.8 part by weight.

For example, in a preferred embodiment, the compound of Formula (3) comprises any one of a compound of Formula (3-1), a compound of Formula (3-2), a compound of Formula (3-3), a compound of Formula (3-4) and a compound of Formula (3-5) or a combination thereof, the compound of Formula (4) comprises any one of a compound of Formula (4-1), a compound of Formula (4-2), a compound of Formula (4-3) and a compound of Formula (4-4) or a combination thereof, and the compound of Formula (5) comprises any one of a compound of Formula (5-1), a compound of Formula (5-2) and a compound of Formula (5-3) or a combination thereof, wherein the structures of these compounds are shown above.

For example, in one embodiment, the resin composition of the present disclosure may further comprise an unsaturated C═C double bond-containing crosslinking agent. For example, relative to 100 parts by weight of the unsaturated C═C double bond-containing polyphenylene ether resin, the resin composition according to the present disclosure may comprise 5 parts by weight to 25 parts by weight of an unsaturated C═C double bond-containing crosslinking agent. For example, relative to 100 parts by weight of the unsaturated C═C double bond-containing polyphenylene ether resin, the amount of the unsaturated C═C double bond-containing crosslinking agent may be for example 5, 10, 15, 20 or 25 parts by weight, but not limited thereto.

The unsaturated C═C double bond-containing crosslinking agent suitable for the resin composition of the present disclosure refers to an unsaturated C═C double bond-containing small molecule compound with a molecular weight of less than or equal to 1000, and the molecular weight thereof is preferably between 100 and 900, more preferably between 100 and 800. For example, the unsaturated C═C double bond-containing crosslinking agent is any one of bis (vinylphenyl) ethane (BVPE), divinylbenzene (DVB), divinylnaphthalene, divinylbiphenyl, triallyl isocyanurate (TAIC), triallyl cyanurate (TAC), vinylbenzocyclobutene (VBCB), bis (vinylbenzyl) ether (BVBE), trivinyl cyclohexane (TVCH), diallyl bisphenol A (DABPA), acrylate with two or more functional groups (such as but not limited to diallyl isophthalate (DAIP)), butadiene, decadiene, octadiene and a combination thereof.

For example, in one embodiment, the resin composition according to the present disclosure may further comprise a polyolefin. For example, relative to 100 parts by weight of the unsaturated C═C double bond-containing polyphenylene ether resin, the resin composition according to the present disclosure may comprise 20 parts by weight to 80 parts by weight of a polyolefin. For example, relative to 100 parts by weight of the unsaturated C═C double bond-containing polyphenylene ether resin, the amount of polyolefin may be 20, 30, 40, 50, 60, 70 or 80 parts by weight, but not limited thereto. The polyolefin suitable for the present disclosure is not particularly limited and

may include any one or more polyolefins useful for making a prepreg, a resin film, a laminate, or a printed circuit board, such as any one or more commercial products, products prepared by the Applicant or a combination thereof. For example, the polyolefin suitable for the resin composition of the present disclosure includes but is not limited to a diene polymer, a monoene polymer, a hydrogenated diene polymer or a combination thereof. The diene refers to a hydrocarbon compound containing two unsaturated C═C double bonds in the molecule, and the monoene refers to a hydrocarbon compound containing one unsaturated C═C double bond in the molecule. The polyolefin suitable for the resin composition of the present disclosure comprises, such as but not limited to, any one of polybutadiene, polyisoprene, styrene-butadiene copolymer, styrene-isoprene copolymer, styrene-butadiene-divinylbenzene polymer, maleic anhydride-adducted styrene-butadiene copolymer, vinyl-polybutadiene-urethane polymer, maleic anhydride-adducted polybutadiene, polymethylstyrene, hydrogenated polybutadiene, hydrogenated polyisoprene, hydrogenated styrene-butadiene-divinylbenzene polymer, hydrogenated maleic anhydride-adducted styrene-butadiene copolymer, hydrogenated styrene-butadiene copolymer, hydrogenated styrene-isoprene copolymer and polyfunctional vinyl aromatic copolymer or a combination thereof.

For example, unless otherwise specified, the polyfunctional vinyl aromatic copolymer may include various polyfunctional vinyl aromatic copolymers disclosed in the US Patent Application Publication No. 20070129502A1, all of which are incorporated herein by reference in their entirety.

For example, in one embodiment, the resin composition described herein may further comprise any one of a benzoxazine resin, an epoxy resin, a polyester resin, a phenol resin, an amine curing agent, a polyamide, a polyimide, a styrene maleic anhydride, a maleimide resin different from the compound of Formula (1), a cyanate ester and a maleimide triazine resin or a combination thereof.

Unless otherwise specified, in the resin composition of the present disclosure, relative to 100 parts by weight of the unsaturated C═C double bond-containing polyphenylene ether resin, the amount of a benzoxazine resin, an epoxy resin, a polyester resin, a phenol resin, a polyamide, a polyimide, a styrene maleic anhydride, a maleimide resin different from the compound of Formula (1), a cyanate ester or a maleimide triazine resin is not particularly limited and may be adjusted as needed, such as ranging from 1 part by weight to 100 parts by weight, such as but not limited to 1 part by weight, 10 parts by weight, 15 parts by weight, 20 parts by weight, 25 parts by weight, 50 parts by weight or 100 parts by weight. Unless otherwise specified, in the resin composition of the present disclosure, relative to 100 parts by weight of the unsaturated C═C double bond-containing polyphenylene ether resin, the amount of an amine curing agent is not particularly limited and may for example range from 1 part by weight to 15 parts by weight, such as but not limited to 1 part by weight, 4 parts by weight, 7.5 parts by weight, 12 parts by weight or 15 parts by weight.

According to the present disclosure, for example, the benzoxazine resin may be any benzoxazine resins known in the field to which this disclosure pertains. Examples include but are not limited to bisphenol A benzoxazine resin, bisphenol F benzoxazine resin, phenolphthalein benzoxazine resin, dicyclopentadiene benzoxazine resin, phosphorus-containing benzoxazine resin, diamino benzoxazine resin and phenyl group-modified, vinyl group-modified or allyl group-modified benzoxazine resin. Commercially available products include LZ-8270 (phenolphthalein benzoxazine resin), LZ-8298 (phenolphthalein benzoxazine resin), LZ-8280 (bisphenol F benzoxazine resin) and LZ-8290 (bisphenol A benzoxazine resin) available from Huntsman, and KZH-5031 (vinyl-modified benzoxazine resin) and KZH-5032 (phenyl-modified benzoxazine resin) available from Kolon Industries Inc. The diamino benzoxazine resin may be diaminodiphenylmethane benzoxazine resin, diaminodiphenyl ether benzoxazine resin, diaminodiphenyl sulfone benzoxazine resin, diaminodiphenyl sulfide benzoxazine resin or a combination thereof, but not limited thereto.

According to the present disclosure, for example, the epoxy resin may be any epoxy resins known in the field to which this disclosure pertains. In terms of improving the heat resistance of the resin composition, the epoxy resin may include, but not limited to, any one of bisphenol A epoxy resin, bisphenol F epoxy resin, bisphenol S epoxy resin, bisphenol AD epoxy resin, novolac epoxy resin, trifunctional epoxy resin, tetrafunctional epoxy resin, multifunctional novolac epoxy resin, dicyclopentadiene (DCPD) epoxy resin, phosphorus-containing epoxy resin, p-xylene epoxy resin, naphthalene epoxy resin (e.g., naphthol epoxy resin), benzofuran epoxy resin, isocyanate-modified epoxy resin, or a combination thereof. According to the present disclosure, for example, the novolac epoxy resin may be phenol novolac epoxy resin, bisphenol A novolac epoxy resin, bisphenol F novolac epoxy resin, biphenyl novolac epoxy resin, phenol benzaldehyde epoxy resin, phenol aralkyl novolac epoxy resin or o-cresol novolac epoxy resin. According to the present disclosure, for example, the phosphorus-containing epoxy resin may be DOPO (9,10-dihydro-9-oxa-10-phosphaphenanthrene-10-oxide) epoxy resin, DOPO-HQ epoxy resin or a combination thereof. The DOPO epoxy resin may be any one or more selected from DOPO-containing phenol novolac epoxy resin, DOPO-containing o-cresol novolac epoxy resin and DOPO-containing bisphenol-A novolac epoxy resin;

the DOPO-HQ epoxy resin may be any one or more selected from DOPO-HQ-containing phenol novolac epoxy resin, DOPO-HQ-containing o-cresol novolac epoxy resin and DOPO-HQ-containing bisphenol-A novolac epoxy resin, but not limited thereto.

According to the present disclosure, for example, the polyester resin may be any polyester resins known in the field to which this disclosure pertains. Examples include but are not limited to a dicyclopentadiene-containing polyester resin and a naphthalene-containing polyester resin. Examples include, but not limited to, HPC-8000 or HPC-8150 available from D.I.C. Corporation.

According to the present disclosure, for example, the phenol resin may be any phenol resins known in the field to which this disclosure pertains. Examples include but are not limited to novolac resin or phenoxy resin, wherein the novolac resin includes phenol novolac resin, o-cresol novolac resin, bisphenol A novolac resin, naphthol novolac resin, biphenyl novolac resin, and dicyclopentadiene phenol resin, but not limited thereto.

According to the present disclosure, for example, the amine curing agent may be any amine curing agents known in the field to which this disclosure pertains. Examples include but are not limited to any one or a combination of diamino diphenyl sulfone, diamino diphenyl methane, diamino diphenyl ether, diamino diphenyl sulfide and dicyandiamide.

According to the present disclosure, for example, the polyamide may be any polyamides known in the field to which this disclosure pertains. Examples include but are not limited to various commercially available polyamide resin products.

According to the present disclosure, for example, the polyimide may be any polyimides known in the field to which this disclosure pertains. Examples include but are not limited to various commercially available polyimide resin products.

According to the present disclosure, for example, the styrene maleic anhydride may be any styrene maleic anhydride known in the field to which this disclosure pertains, wherein the molar ratio of styrene (St) to maleic anhydride (MA) may be 1/1, 2/1, 3/1, 4/1, 6/1, 8/1 or 12/1. Examples include but are not limited to styrene maleic anhydride copolymers such as SMA-1000, SMA-2000, SMA-3000, EF-30, EF-40, EF-60 and EF-80 available from Cray Valley, or styrene maleic anhydride copolymers such as C400, C500, C700 and C900 available from Polyscope.

According to the present disclosure, for example, the maleimide resin different from the compound of Formula (1) may be any maleimide resin different from the compound of Formula (1) known in the field to which this disclosure pertains. Examples include but are not limited to: 4,4′-diphenylmethane bismaleimide, polyphenylmethane maleimide (a.k.a. oligomer of phenylmethane maleimide), bisphenol A diphenyl ether bismaleimide, 3,3′-dimethyl-5,5′-diethyl-4,4′-diphenylmethane bismaleimide, 3,3′-dimethyl-5,5′-dipropyl-4,4′-diphenylmethane bismaleimide, m-phenylene bismaleimide, 4-methyl-1,3-phenylene bismaleimide, 1,6-bismaleimide-(2,2,4-trimethyl) hexane, N-2,3-xylylmaleimide, N-2,6-xylyl maleimide, N-phenylmaleimide, vinyl benzyl maleimide (VBM), maleimide containing a biphenyl structure, maleimide resin containing a C10 to C50 aliphatic structure, maleimide containing isopropyl and m-arylene structures, prepolymer of diallyl compound and maleimide resin, prepolymer of diamine and maleimide resin, prepolymer of multi-functional amine and maleimide resin, prepolymer of acid phenol compound and maleimide resin, or a combination thereof. These components should be construed as including their modifications.

For example, the maleimide resin different from the compound of Formula (1) includes but is not limited to products such as BMI-1000, BMI-1000H, BMI-1100, BMI-1100H, BMI-2000, BMI-2300, BMI-3000, BMI-3000H, BMI-4000, BMI-5000, BMI-5100, BMI-TMH, BMI-7000, and BMI-7000H available from Daiwakasei Industry, products such as BMI-70 and BMI-80 available from K. I Chemical Industry Co., Ltd., or products such as MIR-3000 and MIR-5000 available from Nippon Kayaku.

For example, the maleimide resin containing a C10 to C50 aliphatic structure, also known as imide-extended maleimide resin, may include various imide-extended maleimide resins disclosed in the TW Patent Application Publication No. 200508284A, all of which are incorporated herein by reference in their entirety. Examples of the maleimide resin containing a C10 to C50 aliphatic structure suitable for the present disclosure include, but not limited to, products such as BMI-689, BMI-1400, BMI-1500, BMI-1700, BMI-2500, BMI-3000, BMI-5000 and BMI-6000 available from Designer Molecules Inc.

According to the present disclosure, for example, the cyanate ester may be any cyanate ester resins known in the field to which this disclosure pertains, such as a compound having an Ar—O—C═N structure, wherein Ar may be a substituted or unsubstituted aromatic group. In terms of improving the heat resistance of the resin composition, examples include but are not limited to novolac cyanate ester resin, bisphenol A cyanate ester resin, bisphenol F cyanate ester resin, dicyclopentadiene-containing cyanate ester resin, naphthalene-containing cyanate ester resin, phenolphthalein cyanate ester resin, adamantane cyanate ester resin, fluorene cyanate ester resin or a combination thereof. The novolac cyanate ester resin may be bisphenol A novolac cyanate ester resin, bisphenol F novolac cyanate ester resin or a combination thereof. For example, the cyanate ester resin may be available under the product name Primaset PT-15, PT-30S, PT-60S, BA-200, BA-230S, BA-3000S, BTP-2500, BTP-6020S, DT-4000, DT-7000, ULL950S, HTL-300, CE-320, LVT-50, or LeCy sold by Lonza.

According to the present disclosure, for example, the maleimide triazine resin may be any maleimide triazine resin known in the field to which this disclosure pertains. Examples include but are not limited to: the maleimide triazine resin obtained by polymerizing bisphenol A cyanate ester resin and maleimide resin, the maleimide triazine resin obtained by polymerizing bisphenol F cyanate ester resin and maleimide resin, the maleimide triazine resin obtained by polymerizing phenol novolac cyanate ester resin and maleimide resin and the maleimide triazine resin obtained by polymerizing dicyclopentadiene-containing cyanate ester resin and maleimide resin. In one embodiment, the maleimide triazine resin may be obtained by polymerizing a cyanate ester resin and a maleimide resin at any molar ratio; for example, the molar ratio of maleimide resin to cyanate ester resin may be from 1:1 to 1:10, such as but not limited to 1:1, 1:2, 1:4, 1:6, 1:8 or 1:10.

For example, in one embodiment, the resin composition further comprises any one of an inorganic filler, a flame retardant, a curing accelerator different from the compound of Formula (2), a solvent, a silane coupling agent, a coloring agent and a toughening agent or a combination thereof.

According to the present disclosure, for example, the inorganic filler may be any one or more inorganic fillers suitable for preparing a prepreg, a resin film, a laminate or a printed circuit board, examples thereof including but not limited to silica (fused, non-fused, porous or hollow type), aluminum oxide, aluminum hydroxide, magnesium oxide, magnesium hydroxide, calcium carbonate, aluminum nitride, boron nitride, aluminum silicon carbide, silicon carbide, titanium dioxide, barium titanate, lead titanate, strontium titanate, calcium titanate, magnesium titanate, barium zirconate, lead zirconate, magnesium zirconate, lead zirconate titanate, zinc molybdate, calcium molybdate, magnesium molybdate, ammonium molybdate, zinc molybdate-modified talc, zinc oxide, zirconium oxide, mica, boehmite (AlOOH), calcined talc, talc, silicon nitride, zirconium tungstate, petalite, calcined kaolin or a combination thereof. Moreover, the inorganic filler can be spherical (including solid sphere or hollow sphere), fibrous, plate-like, particulate, flake-like or whisker-like and can be optionally pretreated by a silane coupling agent. For example, in one embodiment, relative to 100 parts by weight of the unsaturated C═C double bond-containing polyphenylene ether resin, the resin composition of the present disclosure may further comprise 10 parts by weight to 300 parts by weight of inorganic filler, preferably 50 parts by weight to 300 parts by weight of inorganic filler, more preferably 100 parts by weight to 200 parts by weight of inorganic filler, but not limited thereto.

According to the present disclosure, for example, the flame retardant may be any one or more flame retardants suitable for preparing a prepreg, a resin film, a laminate or a printed circuit board, such as but not limited to a phosphorus-containing flame retardant or a bromine-containing flame retardant. The bromine-containing flame retardant preferably comprises decabromodiphenyl ethane. The phosphorus-containing flame retardant may preferably include: hydroquinone bis-(diphenyl phosphate), bisphenol A bis-(diphenylphosphate), tri (2-carboxyethyl) phosphine (TCEP), phosphoric acid tris (chloroisopropyl) ester, trimethyl phosphate (TMP), dimethyl methyl phosphonate (DMMP), resorcinol bis (dixylenyl phosphate) (RDXP, such as commercially available PX-200, PX-201, and PX-202), ammonium polyphosphate, melamine polyphosphate, phosphazene (such as commercially available SPB-100, SPH-100, and SPV-100), 9,10-dihydro-9-oxa-10-phosphaphenanthrene-10-oxide (DOPO) compound and its derivatives or resins (e.g., di-DOPO compound), diphenylphosphine oxide (DPPO) compound and its derivatives or resins (e.g., di-DPPO compound), melamine cyanurate, tri-hydroxy ethyl isocyanurate, aluminium phosphinate (e.g., commercially available OP-930 and OP-935), or a combination thereof.

For example, in one embodiment, the flame retardant may be a flame retardant commercially available from Katayama Chemical Industries Co., Ltd., such as but not limited to V1, V2, V3, V4, V5, V7, S-2, S-4, E-4c, E-7c, E-8g, E-9g, E-10g, E-100, B-3, W-1o, W-2h, W-2o, W-3o, W-4o, OX-1, OX-2, OX-4, OX-6, OX-6+, OX-7, OX-7+, OX-13, BPE-1, BPE-3, HyP-2, API-9, CMPO, ME-20, C-1R, C-1S, C-3R, C-3S or C-11R. The flame retardant of the present disclosure may include one or more of the above flame retardants.

For example, in one embodiment, relative to 100 parts by weight of the unsaturated C═C double bond-containing polyphenylene ether resin, the resin composition of the present disclosure may further comprise 1 part by weight to 100 parts by weight of flame retardant, preferably 5 parts by weight to 50 parts by weight of flame retardant, but not limited thereto.

According to the present disclosure, for example, the curing accelerator different from the compound of Formula (2) may comprise a catalyst, such as a Lewis base or a Lewis acid. The Lewis base may comprise any one or more of imidazole, boron trifluoride-amine complex, ethyltriphenyl phosphonium chloride, 2-methylimidazole (2 MI), 2-phenyl-1H-imidazole (2PZ), 2-ethyl-4-methylimidazole (2E4MZ), triphenylphosphine (TPP) and 4-dimethylaminopyridine (DMAP). The Lewis acid may comprise metal salt compounds, such as those of manganese, iron, cobalt, nickel, copper and zinc, such as zinc octanoate or cobalt octanoate. The curing accelerator also includes a curing initiator different from the compound of Formula (2), such as a peroxide capable of producing free radicals. The curing initiator comprises but is not limited to: dicumyl peroxide (DCP), t-butyl peroxybenzoate, dibenzoyl peroxide (BPO), 2,5-dimethyl-2,5-di(t-butylperoxy)-3-hexyne (25B), bis(t-butylperoxy isopropyl) benzene or a combination thereof. For example, in one embodiment, relative to 100 parts by weight of the unsaturated C═C double bond-containing polyphenylene ether resin, the resin composition of the present disclosure may further comprise 0.001 part by weight to 2 parts by weight of a curing accelerator different from the compound of Formula (2), preferably 0.01 part by weight to 1.5 parts by weight of a curing accelerator different from the compound of Formula (2), more preferably 0.1 part by weight to 1.0 part by weight of a curing accelerator different from the compound of Formula (2), but not limited thereto.

According to the present disclosure, for example, the solvent may be any solvent suitable for dissolving the resin composition disclosed herein, examples including, but not limited to, methanol, ethanol, ethylene glycol monomethyl ether, acetone, butanone (methyl ethyl ketone), methyl isobutyl ketone, cyclohexanone, N-methyl-pyrrolidone, toluene, xylene, methoxyethyl acetate, ethoxyethyl acetate, propoxyethyl acetate, ethyl acetate, dimethylformamide, dimethylacetamide, propylene glycol monomethyl ether acetate, or a mixture thereof. The amount of solvent is determined in view of the purpose of completely dissolving the resin and adjusting to a certain total solid content of the resin composition. For example, in one embodiment, the amount of solvent is added to adjust the total solid content of the resin composition to 50% to 85% by weight, but not limited thereto.

According to the present disclosure, for example, the silane coupling agent may comprise silane (such as but not limited to siloxane), which may be further categorized according to the functional groups into amino silane, epoxide silane, vinyl silane, hydroxyl silane, isocyanate silane, methacryloxy silane and acryloxy silane. For example, in one embodiment, relative to 100 parts by weight of the unsaturated C═C double bond-containing polyphenylene ether resin, the resin composition of the present disclosure may further comprise 0.001 part by weight to 20 parts by weight of silane coupling agent, preferably 0.01 part by weight to 10 parts by weight of silane coupling agent, but not limited thereto.

According to the present disclosure, for example, the coloring agent may comprise but is not limited to dye or pigment. For example, in one embodiment, relative to 100 parts by weight of the unsaturated C═C double bond-containing polyphenylene ether resin, the resin composition of the present disclosure may further comprise 0.001 part by weight to 10 parts by weight of coloring agent, preferably 0.01 part by weight to 5 parts by weight of coloring agent, but not limited thereto.

According to the present disclosure, the main purpose of adding a toughening agent is to improve the toughness of the resin composition. For example, the toughening agent suitable for the present disclosure may comprise, but not limited to, carboxyl-terminated butadiene acrylonitrile rubber (CTBN rubber), core-shell rubber, ethylene propylene rubber or a combination thereof. For example, in one embodiment, relative to 100 parts by weight of the unsaturated C═C double bond-containing polyphenylene ether resin, the resin composition of the present disclosure may further comprise 1 part by weight to 20 parts by weight of toughening agent, preferably 3 parts by weight to 10 parts by weight of toughening agent, but not limited thereto.

In addition to the aforesaid resin composition, the present disclosure also provides an article made from the resin composition, such as those suitable for use as components in various electronic products, including but not limited to a prepreg, a resin film, a laminate or a printed circuit board.

For example, the resin composition of the present disclosure can be used to make a prepreg, which comprises a reinforcement material and a layered structure disposed thereon. The layered structure is formed by heating the resin composition at a high temperature to the B-stage. Suitable baking temperature for making a prepreg may be for example 120° C. to 180° C., preferably 120° C. to 160° C. For example, the reinforcement material may be any one of a fiber material, woven fabric, and non-woven fabric, and the woven fabric preferably comprises fiberglass fabrics. The type of the fiberglass fabric is not particularly limited and may be any fiberglass fabrics used for a printed circuit board, such as E-glass fabric, D-glass fabric, S-glass fabric, T-glass fabric, L-glass fabric, Q-glass fabric or QL-glass fabric (glass fabric with hybrid structure made of Q-glass and L-glass). The fiber may comprise yarns and rovings, in spread form or standard form, and the shape of terminal face may be round or flat. Non-woven fabric preferably comprises liquid crystal polymer non-woven fabric, such as polyester non-woven fabric, polyurethane non-woven fabric and so on, but not limited thereto. Woven fabric may also comprise liquid crystal polymer woven fabric, such as polyester woven fabric, polyurethane woven fabric and so on, but not limited thereto. The reinforcement material may increase the mechanical strength of the prepreg. In one preferred embodiment, the reinforcement material can also be optionally pre-treated by a silane coupling agent. The prepreg may be further heated and cured to the C-stage to form an insulation layer.

For example, the resin composition of the present disclosure can be used to make a resin film, which is prepared by heating and baking to semi-cure the resin composition. The resin composition may be selectively coated on a supporting material, which includes but is not limited to a liquid crystal polymer film, a polytetrafluoroethylene film, a polyethylene terephthalate film (PET film), a polyimide film (PI film), a metal foil or a resin-coated copper (RCC), followed by heating and baking to semi-cure the resin composition to form the resin film.

For example, the resin composition of the present disclosure may be made into a laminate, which comprises at least two metal foils and at least one insulation layer disposed between the metal foils, wherein the insulation layer is made by curing the resin composition at high temperature and high pressure to the C-stage, a suitable curing temperature being for example between 190° C. and 220° C. and preferably between 200° C. and 210° C. and a suitable curing time being 90 to 180 minutes and preferably 120 to 150 minutes, a suitable lamination pressure being for example between 300 psi and 550 psi and preferably between 400 psi and 500 psi. The insulation layer may be obtained by curing the aforesaid prepreg or resin film. The metal foil may contain copper, aluminum, nickel, platinum, silver, gold or alloy thereof, such as a copper foil. In a preferred embodiment, the laminate is a copper-clad laminate.

In one embodiment, the laminate may be further processed by trace formation processes to obtain a printed circuit board. In one embodiment of making the printed circuit board according to the present disclosure, a double-sided copper-clad laminate (such as product EM-827, available from Elite Electronic Material (Kunshan) Co., Ltd.) with a thickness of 28 mil and having 1-ounce (oz) HTE (high temperature elongation) copper foils may be used and subject to drilling and then electroplating, so as to form electrical conduction between the top layer copper foil and the bottom layer copper foil. Then the top layer copper foil and the bottom layer copper foil are etched to form inner layer circuits. Then brown oxidation and roughening are performed on the inner layer circuits to form uneven structures on the surface to increase roughness. Next, a vacuum lamination apparatus is used to laminate the assembly of a copper foil, the prepreg, the inner layer circuit board, the prepreg and a copper foil stacked in said order by heating at 190° C. to 220° C. for 90 to 180 minutes to cure the insulation material of the prepregs. Next, black oxidation, drilling, copper plating and other known circuit board processes are performed on the outmost copper foils so as to obtain the printed circuit board.

For example, in one embodiment, an article made from the resin composition from each embodiment contains a reinforcement material or a supporting material and a semi-cured or cured product obtained by heating and chemically crosslinking the resin composition.

For example, in one embodiment, the resin composition disclosed herein or various articles made therefrom may preferably have any one, more or all of the following properties:
a ratio of loss modulus to storage modulus as measured by reference to IPC-TM-650 2.4.24.4 of less than or equal to 0.07, such as between 0.04 and 0.07, such as a ratio of loss modulus to storage modulus of less than 0.05 and greater than or equal to 0.04;
a percent of thermal expansion in Z-axis as measured by reference to IPC-TM-650 2.4.24.5 of less than or equal to 1.5%, such as between 1.0% and 1.5%;
a temperature coefficient of dielectric constant as measured by reference to IPC-TM-650 2.5.5.13 of less than or equal to 12.0 ppm/° C., such as between 4.1 ppm/° C. and 11.8 ppm/° C., such as between 4.1 ppm/° C. and 4.9 ppm/° C.;
a temperature coefficient of dissipation factor as measured by reference to IPC-TM-650 2.5.5.13 of less than or equal to 3400 ppm/° C., such as between 2917 ppm/° C. and 3395 ppm/° C., such as between 2917 ppm/° C. and 2999 ppm/° C.;
a solder dip delamination rate of multi-layer board as measured by reference to IPC-TM-650 2.4.13.1 of less than or equal to 5%, such as between 0% and 5%;
a passive intermodulation as measured by reference to IEC-62037 of less than or equal to-162.0 dBc, such as between-162.8 dBc and-169.5 dBc; and
a radial filling capacity value of prepreg of greater than or equal to 70%, such as between 70% and 100%, such as a radial filling capacity value of prepreg of greater than 70% and less than or equal to 100%.

Raw materials below were used to prepare the resin compositions of various Examples and Comparative Examples of the present disclosure according to the amount listed in Table 1 to Table 6 and further fabricated to prepare test samples.

Materials and reagents used in Examples and Comparative Examples disclosed herein are listed below:
SA9000: (meth) acryloyl group-containing polyphenylene ether resin, available from Sabic.
OPE-2st 1200: vinylbenzyl group-containing polyphenylene ether resin, available from Mitsubishi Gas Chemical Co., Inc.
OPE-2st 2200: vinylbenzyl group-containing polyphenylene ether resin, available from Mitsubishi Gas Chemical Co., Inc.
Compound of Formula (1-3): commercially available, wherein m1 is a value of 0 to 20, m2 is a value of 0 to 20, and ml +m2 =0.5 to 20.
Compound of Formula (2-1): 2,3-dimethyl-2,3-diphenylbutane, available from Wuxi Zhufeng Fine Chemical Co., Ltd.
Compound of Formula (2-2): 1,1,2,2-tetraphenylethane, available from Wuxi Zhufeng Fine Chemical Co., Ltd.
Compound of Formula (2-3): 4,4′-(2,3-dimethylbutan-2,3-diyl)diisopropylbenzene, available from Wuxi Zhufeng Fine Chemical Co., Ltd.
Compound of Formula (2-4): synthesized by Applicant, as described in detail below.
Compound of Formula (2-5): synthesized by Applicant, as described in detail below.
Compound of Formula (2-6): synthesized by Applicant, as described in detail below.
Compound of Formula (3-1): available from Changzhou Jiana Chemical Co., Ltd.
Compound of Formula (3-2): available from Changzhou Jiana Chemical Co., Ltd.
Compound of Formula (4-1): available from Changzhou Jiana Chemical Co., Ltd.
Compound of Formula (4-2): available from Changzhou Jiana Chemical Co., Ltd.
Compound of Formula (5-1): available from Changzhou Jiana Chemical Co., Ltd.
G1726: hydrogenated styrene-butadiene-styrene triblock copolymer, available from KRATON.
B-3000: polybutadiene, available from Nippon Soda Co., Ltd.
Polyfunctional vinyl aromatic copolymer: styrene-divinylbenzene-ethylvinylbenzene copolymer, available from Nippon Steel Chemical & Material Co., Ltd.
DVB: divinylbenzene, available from Shanghai Macklin Biochemical Co., Ltd.
BVPE: bis (vinylphenyl) ethane, available from Linchuan Chemical Co., Ltd.
TAIC: triallyl isocyanurate, available from Kingyorker Enterprise Co., Ltd.
BMI-1: commercially available, having a structure below:

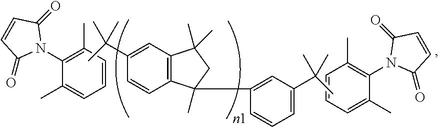

wherein n1 is a value of 0.5 to 20.
BMI-2: commercially available, having a structure below:

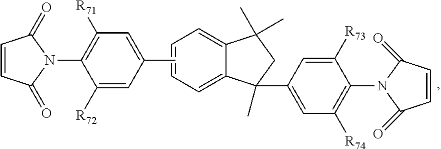

wherein R₇₁ to R₇₄ are independently a hydrogen atom or a C1 to C3 alkyl group.
25B: 2,5-dimethyl-2,5-di (t-butylperoxy)-3-hexyne, available from NOF Corporation.
DCP: dicumyl peroxide, available from NOF Corporation.
2E4MZ: 2-ethyl-4-methylimidazole, available from Kingyorker Enterprise Co., Ltd.
SC-2500-SVJ: spherical silica, available from Admatechs.
Solvent: toluene and methyl ethyl ketone (MEK), both available from Sinopec Group. The amount of solvent is shown as “PA” in the Tables to indicate a “proper amount” to represent an amount of solvent used to achieve a 60% to 68% total solid content (S/C =60% to 68%) of the resin composition.

### Preparation of Compound of Formula (2-4)

In a three-necked flask under nitrogen protection, 1 mol of 1,1′-bis (4-bromo phenyl) ethane, 1.2 mol of vinylmagnesium bromide in a tetrahydrofuran solution and 0.05 mol of palladium dichloride were added in such order and refluxed for 24 hours. A saturated aqueous ammonium chloride solution was added to quench the reaction, which was then extracted with a dichloromethane solution. The organic phases were combined and evaporated to remove the solvent so as to obtain a crude product, which was separated by column chromatography to obtain 0.9 mol of 1,1′-bis(4-vinyl phenyl)ethane.

In a three-necked flask, 0.8 mol of 1,1′-bis(4-vinylphenyl)ethane, 1.6 mol of N-bromosuccinimide, 0.05 mol of dibenzoyl peroxide and an appropriate amount of carbon tetrachloride were added in such order and refluxed for 12 hours. The reaction solution was washed three times with a sodium thiosulfate solution, and the solvent was evaporated to obtain a dry powder solid, which was recrystallized by acetone to obtain 1,1′-bis(4-vinylphenyl)-1-bromoethane.

In a reaction flask, 0.5 mol of 1,1′-bis (4-vinylphenyl)-1-bromoethane and 1 mol of silver-activated zinc powder were added in such order and reacted for 2 hours. After cooling to room temperature, saturated ammonium chloride was used to quench the reaction, which was filtered to remove unreacted zinc powder and separated by column chromatography to obtain 2,3-tetra(4-vinylphenyl)butane, marked as a compound of Formula (2-4), as shown below.

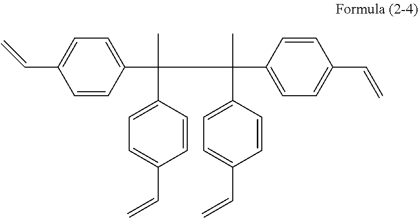 [SMILES: C=Cc1ccc(C(C)(c2ccc(C=C)cc2)C(C)(c2ccc(C=C)cc2)c2ccc(C=C)cc2)cc1]

### Preparation of Compound of Formula (2-5)

In a reaction flask, 0.01 mol of 4-isopropylbenzaldehyde, 0.02 mol of N-bromosuccinimide, 0.05 mol of dibenzoyl peroxide and 10 ml of carbon tetrachloride were added and refluxed for 12 hours. After concentrated, the product was purified by column chromatography to obtain 2-bromo-2-(4-formylphenyl)propane.

In a reaction flask, 0.01 mol of 2-bromo-2-(4-formylphenyl)propane and 0.02 mol of silver-activated zinc powder were added and reacted for 2 hours. The mixture was filtered to remove unreacted zinc powder and purified by column chromatography to obtain 2,3-dimethyl-2,3-bis(4-formylphenyl)butane.

Tetrahydrofuran was added with anhydrous calcium chloride and stood still overnight to remove water. In a four-necked flask, 0.01 mol of 2,3-dimethyl-2,3-bis (4-formylphenyl) butane, 0.015 mol of methyltriphenylphosphonium bromide and 15 ml of tetrahydrofuran were added, and 0.015 mol of potassium tert-butoxide was added slowly under an iced water bath condition. The mixture was reacted at room temperature for 2 hours. A saturated ammonium chloride aqueous solution was added to inactivate phosphorus ylide and filtered to remove excess salt to obtain a filtrate, which was added with 0.03 mol of calcium bromide, stirred for 18 hours and filtered so as to obtain a crude product, which was purified by column chromatography to obtain 2,3-dimethyl-2,3-bis(4-vinylphenyl)butane, marked as a compound of Formula (2-5), as shown below.

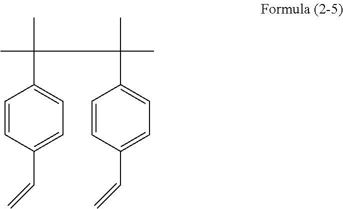 [SMILES: C=Cc1ccc(C(C)(C)C(C)(C)c2ccc(C=C)cc2)cc1]

### Preparation of Compound of Formula (2-6)

Under nitrogen gas protection, 0.6 mol of acetophenone in a tetrahydrofuran solution was added to a three-necked flask, which was added dropwise with 1.8 mol of titanium tetrachloride in an iced bath. After the dropwise addition was completed, the reaction was stirred at room temperature for 10 minutes and refluxed for 12 hours. After the reaction was completed, as confirmed by TLC, it was cooled to room temperature and added with a potassium carbonate solution to precipitate. The precipitate was filtered to obtain a filter cake, which was then extracted with dichloromethane. Finally, the solvent was evaporated to obtain 0.25 mol of 1,2-dimethylstilbene.

In a three-necked flask, 0.24 mol of peroxybenzoate in a dichloromethane solution was added dropwise to 0.2 mol of 1,2-dimethylstilbene in a dichloromethane solution under an iced bath. After the dropwise addition was completed, the reaction was carried out at room temperature for 24 hours and completed, as confirmed by TLC. After that, the organic phase was extracted by sodium thiosulfate solution and sodium bicarbonate solution; the solvent was evaporated to obtain a dry powder solid, which was recrystallized by acetone to obtain 0.16 mol of 1,2-dimethylstilbene epoxide.

In a three-necked flask, 0.15 mol of 1,2-dimethylstilbene epoxide in a tetrahydrofuran solution was added, and 0.6 mol of a 10% sulfuric acid solution was added at room temperature. After refluxing for 8 hours, the reaction was completed. The reaction solution was poured into 5 liters of cold water to precipitate a solid, which was filtered to obtain a filter cake. After recrystallization by ethanol, 0.14 mol of 1,2-dimethyldiphenylbutanediol was obtained.

0.1 mol of 1,2-dimethyldiphenylbutanediol, 0.15 mol of methacryloyl chloride

and toluene were added in such order to a three-necked flask equipped with a water separator, and 0.01 mol of concentrated sulfuric acid was added. After refluxing for 24 hours, the reaction solution was neutralized with a 10% sodium hydroxide solution. The reaction solution was extracted with ethyl acetate and washed with saturated brine. The solvent was evaporated to obtain a dry powder solid, which was recrystallized by isopropanol/n-hexane to obtain 0.08 mol of 2,3-diphenylbutane-2,3-dimethyl bis(2-methacrylate), which was marked as a compound of Formula (2-6), as shown below.

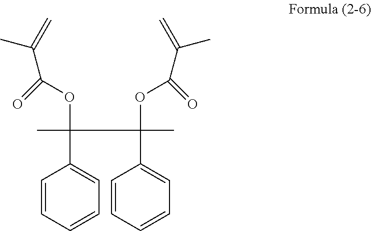 [SMILES: C=C(C)C(=O)OC(C)(c1ccccc1)C(C)(OC(=O)C(=C)C)c1ccccc1]

Compositions and test results of resin compositions of Examples and Comparative Examples used herein are listed in the tables below:

TABLE 1
Resin compositions of Examples (in part by weight) and test results

| Component | | E1 | E2 | E3 | E4 | E5 |
|---|---|---|---|---|---|---|
| unsaturated C═C double | SA9000 | 100 | 100 | 100 | 100 | 100 |
| bond-containing polyphenylene | OPE-2st 1200 | | | | | |
| ether resin | OPE-2st 2200 | | | | | |
| compound of Formula (1) | Formula (1-3) | 50 | 10 | 80 | 50 | 50 |
| compound of Formula (2) | Formula (2-1) | 10 | 10 | 10 | 1 | 20 |
| | Formula (2-2) | | | | | |
| | Formula (2-3) | | | | | |
| | Formula (2-4) | | | | | |
| | Formula (2-5) | | | | | |
| | Formula (2-6) | | | | | |
| compound of Formula (3) to | Formula (3-1) | | | | | |
| Formula (5) | Formula (3-2) | | | | | |
| | Formula (4-1) | | | | | |
| | Formula (4-2) | | | | | |
| | Formula (5-1) | | | | | |
| polyolefin | G1726 | | | | | |
| | B-3000 | | | | | |
| | polyfunctional vinyl | | | | | |
| | aromatic copolymer | | | | | |
| unsaturated C═C double | DVB | | | | | |
| bond-containing crosslinking | BVPE | | | | | |
| agent | TAIC | | | | | |
| maleimide resin different from | BMI-1 | | | | | |
| compound of Formula (1) | BMI-2 | | | | | |
| curing accelerator different from | 25B | | | | | |
| compound of Formula (2) | DCP | | | | | |
| | 2E4MZ | | | | | |
| inorganic filler | SC-2500-SVJ | 150 | 150 | 150 | 150 | 150 |
| solvent | toluene:MEK = 3:7 | PA | PA | PA | PA | PA |

| Item | Unit | E1 | E2 | E3 | E4 | E5 |
|---|---|---|---|---|---|---|
| tanδ | none | 0.06 | 0.07 | 0.05 | 0.06 | 0.06 |
| Z-PTE | % | 1.3 | 1.5 | 1.1 | 1.5 | 1.2 |
| TcDk | ppm/° C. | 8.0 | 10.0 | 7.1 | 7.8 | 10.8 |
| TcDf | ppm/° C. | 3258 | 3323 | 3225 | 3164 | 3353 |
| radial filling capacity value of | % | 80 | 70 | 90 | 70 | 90 |
| prepreg | | | | | | |
| solder dip delamination rate of | % | 0 | 0 | 0 | 0 | 0 |
| multi-layer board | | | | | | |
| PIM | dBc | −165.5 | −163.1 | −167.2 | −166.0 | −164.8 |

TABLE 2
Resin compositions of Examples (in part by weight) and test results

| Component | | E6 | E7 | E8 | E9 | E10 |
|---|---|---|---|---|---|---|
| unsaturated C═C double | SA9000 | | | 100 | | |
| bond-containing polyphenylene | OPE-2st 1200 | 100 | | | 100 | |
| ether resin | OPE-2st 2200 | | 100 | | | 100 |
| compound of Formula (1) | Formula (1-3) | 50 | 50 | 50 | 80 | 10 |
| compound of Formula (2) | Formula (2-1) | | | | | |
| | Formula (2-2) | 10 | | | | |
| | Formula (2-3) | | 10 | | | |
| | Formula (2-4) | | | 10 | | |
| | Formula (2-5) | | | | 1 | |
| | Formula (2-6) | | | | | 20 |
| compound of Formula (3) to | Formula (3-1) | | | | | |
| Formula (5) | Formula (3-2) | | | | | |
| | Formula (4-1) | | | | | |
| | Formula (4-2) | | | | | |
| | Formula (5-1) | | | | | |
| polyolefin | G1726 | | | | | |
| | B-3000 | | | | | |
| | polyfunctional vinyl | | | | | |
| | aromatic copolymer | | | | | |
| unsaturated C═C double | DVB | | | | | |
| bond-containing crosslinking | BVPE | | | | | |
| agent | TAIC | | | | | |
| maleimide resin different from | BMI-1 | | | | | |
| compound of Formula (1) | BMI-2 | | | | | |
| curing accelerator different from | 25B | | | | | |
| compound of Formula (2) | DCP | | | | | |
| | 2E4MZ | | | | | |
| inorganic filler | SC-2500-SVJ | 150 | 150 | 150 | 150 | 150 |
| solvent | toluene:MEK = 3:7 | PA | PA | PA | PA | PA |

| Item | Unit | E6 | E7 | E8 | E9 | E10 |
|---|---|---|---|---|---|---|
| tanδ | none | 0.05 | 0.05 | 0.04 | 0.04 | 0.04 |
| Z-PTE | % | 1.0 | 1.2 | 1.0 | 1.0 | 1.1 |
| TcDk | ppm/° C. | 11.8 | 9.5 | 8.4 | 8.2 | 7.9 |
| TcDf | ppm/° C. | 3395 | 3344 | 3254 | 3265 | 3245 |
| radial filling capacity value of | % | 75 | 75 | 80 | 75 | 75 |
| prepreg | | | | | | |
| solder dip delamination rate of | % | 0 | 0 | 0 | 0 | 0 |
| multi-layer board | | | | | | |
| PIM | dBc | −164.9 | −165.0 | −163.5 | −163.2 | −162.8 |

TABLE 3
Resin compositions of Examples (in part by weight) and test results

| Component | | E11 | E12 | E13 | E14 | E15 |
|---|---|---|---|---|---|---|
| unsaturated C═C double | SA9000 | 100 | 100 | 100 | 100 | 100 |
| bond-containing polyphenylene | OPE-2st 1200 | | | | | |
| ether resin | OPE-2st 2200 | | | | | |
| compound of Formula (1) | Formula (1-3) | 50 | 50 | 50 | 50 | 50 |
| compound of Formula (2) | Formula (2-1) | 10 | 10 | 10 | 10 | 10 |
| | Formula (2-2) | | | | | |
| | Formula (2-3) | | | | | |
| | Formula (2-4) | | | | | |
| | Formula (2-5) | | | | | |
| | Formula (2-6) | | | | | |
| compound of Formula (3) to | Formula (3-1) | 0.001 | 0.5 | 0.8 | 0.005 | |
| Formula (5) | Formula (3-2) | | | | | 0.001 |
| | Formula (4-1) | | | | | 0.003 |
| | Formula (4-2) | | | | | 0.001 |
| | Formula (5-1) | | | | | |
| polyolefin | G1726 | | | | | |
| | B-3000 | | | | | |
| | polyfunctional vinyl | | | | | |
| | aromatic copolymer | | | | | |
| unsaturated C═C double | DVB | | | | | |
| bond-containing crosslinking | BVPE | | | | | |
| agent | TAIC | | | | | |
| maleimide resin different from | BMI-1 | | | | | |
| compound of Formula (1) | BMI-2 | | | | | |
| curing accelerator different from | 25B | | | | | |
| compound of Formula (2) | DCP | | | | | |
| | 2E4MZ | | | | | |
| inorganic filler | SC-2500-SVJ | 150 | 150 | 150 | 150 | 150 |
| solvent | toluene:MEK = 3:7 | PA | PA | PA | PA | PA |

| Item | Unit | E11 | E12 | E13 | E14 | E15 |
|---|---|---|---|---|---|---|
| tanδ | none | 0.06 | 0.06 | 0.07 | 0.06 | 0.06 |
| Z-PTE | % | 1.3 | 1.3 | 1.5 | 1.3 | 1.3 |
| TcDk | ppm/° C. | 4.9 | 4.5 | 4.1 | 4.7 | 4.6 |
| TcDf | ppm/° C. | 2972 | 2965 | 2961 | 2969 | 2969 |
| radial filling capacity value of | % | 100 | 100 | 100 | 100 | 100 |
| prepreg | | | | | | |
| solder dip delamination rate of | % | 0 | 0 | 5 | 0 | 0 |
| multi-layer board | | | | | | |
| PIM | dBc | −167.8 | −168.5 | −168.8 | −168.1 | −168.2 |

TABLE 4
Resin compositions of Examples (in part by weight) and test results

| Component | | E16 | E17 | E18 | E19 | E20 |
|---|---|---|---|---|---|---|
| unsaturated C═C double | SA9000 | 100 | | 80 | 60 | 80 |
| bond-containing polyphenylene | OPE-2st 1200 | | 100 | 10 | 20 | 10 |
| ether resin | OPE-2st 2200 | | | 10 | 20 | 10 |
| compound of Formula (1) | Formula (1-3) | 50 | 10 | 80 | 30 | 60 |
| compound of Formula (2) | Formula (2-1) | 10 | | | | |
| | Formula (2-2) | | 1 | | | |
| | Formula (2-3) | | | 20 | | |
| | Formula (2-4) | | | | 4 | |
| | Formula (2-5) | | | | | 10 |
| | Formula (2-6) | | | | 1 | 5 |
| compound of Formula (3) to | Formula (3-1) | | | | | |
| Formula (5) | Formula (3-2) | | | | | |
| | Formula (4-1) | | | | | |
| | Formula (4-2) | | | | | |
| | Formula (5-1) | 0.005 | 0.001 | 0.5 | 0.01 | 0.015 |
| polyolefin | G1726 | | | | 10 | 49 |
| | B-3000 | | | | | 1 |
| | polyfunctional vinyl | | | | 10 | 30 |
| | aromatic copolymer | | | | | |
| unsaturated C═C double | DVB | | | | 2 | |
| bond-containing crosslinking | BVPE | | | | 1 | |
| agent | TAIC | | | | 2 | 25 |
| maleimide resin different from | BMI-1 | | | | | |
| compound of Formula (1) | BMI-2 | | | | | |
| curing accelerator different from | 25B | | | | | |
| compound of Formula (2) | DCP | | | | | |
| | 2E4MZ | | | | | |
| inorganic filler | SC-2500-SVJ | 150 | 150 | 150 | 100 | 300 |
| solvent | toluene:MEK = 3:7 | PA | PA | PA | PA | PA |

| Item | Unit | E16 | E17 | E18 | E19 | E20 |
|---|---|---|---|---|---|---|
| tanδ | none | 0.06 | 0.05 | 0.05 | 0.04 | 0.04 |
| Z-PTE | % | 1.3 | 1.3 | 1.0 | 1.0 | 1.0 |
| TcDk | ppm/° C. | 4.5 | 4.6 | 4.2 | 4.9 | 4.7 |
| TcDf | ppm/° C. | 2917 | 2999 | 2959 | 2998 | 2975 |
| radial filling capacity value of | % | 100 | 100 | 100 | 100 | 100 |
| prepreg | | | | | | |
| solder dip delamination rate of | % | 0 | 0 | 0 | 0 | 0 |
| multi-layer board | | | | | | |
| PIM | dBc | −169.5 | −166.6 | −167.0 | −165.1 | −168.0 |

TABLE 5
Resin compositions of Comparative Examples (in part by weight) and test results

| Component | | C1 | C2 | C3 | C4 | C5 |
|---|---|---|---|---|---|---|
| unsaturated C═C double | SA9000 | 100 | 100 | 100 | 100 | 100 |
| bond-containing polyphenylene | OPE-2st 1200 | | | | | |
| ether resin | OPE-2st 2200 | | | | | |
| compound of Formula (1) | Formula (1-3) | 5 | 100 | 50 | 50 | |
| compound of Formula (2) | Formula (2-1) | 10 | 10 | | 25 | 10 |
| | Formula (2-2) | | | | | |
| | Formula (2-3) | | | | | |
| | Formula (2-4) | | | | | |
| | Formula (2-5) | | | | | |
| | Formula (2-6) | | | | | |
| compound of Formula (3) to | Formula (3-1) | | | | | |
| Formula (5) | Formula (3-2) | | | | | |
| | Formula (4-1) | | | | | |
| | Formula (4-2) | | | | | |
| | Formula (5-1) | | | | | |
| polyolefin | G1726 | | | | | |
| | B-3000 | | | | | |
| | polyfunctional vinyl | | | | | |
| | aromatic copolymer | | | | | |
| unsaturated C═C double | DVB | | | | | |
| bond-containing crosslinking | BVPE | | | | | |
| agent | TAIC | | | | | |
| maleimide resin different from | BMI-1 | | | | | 50 |
| compound of Formula (1) | BMI-2 | | | | | |
| curing accelerator different from | 25B | | | | | |
| compound of Formula (2) | DCP | | | | | |
| | 2E4MZ | | | | | |
| inorganic filler | SC-2500-SVJ | 150 | 150 | 150 | 150 | 150 |
| solvent | toluene:MEK = 3:7 | PA | PA | PA | PA | PA |

| Item | Unit | C1 | C2 | C3 | C4 | C5 |
|---|---|---|---|---|---|---|
| tanδ | none | 0.10 | 0.05 | 0.11 | 0.10 | 0.10 |
| Z-PTE | % | 2.0 | 1.1 | 1.8 | 1.3 | 1.8 |
| TcDk | ppm/° C. | 15.8 | 7.0 | 8.8 | 17.9 | 8.9 |
| TcDf | ppm/° C. | 3550 | 3146 | 3259 | 3745 | 3602 |
| radial filling capacity value of | % | 60 | 90 | 60 | 90 | 75 |
| prepreg | | | | | | |
| solder dip delamination rate of | % | 50 | 20 | 100 | 50 | 20 |
| multi-layer board | | | | | | |
| PIM | dBc | −155.0 | −156.1 | −155.6 | −152.2 | −150.6 |

TABLE 6
Resin compositions of Comparative Examples (in part by weight) and test results

| Component | | C6 | C7 | C8 | C9 |
|---|---|---|---|---|---|
| unsaturated C═C double | SA9000 | 100 | 100 | 100 | 100 |
| bond-containing polyphenylene ether | OPE-2st 1200 | | | | |
| resin | OPE-2st 2200 | | | | |
| compound of Formula (1) | Formula (1-3) | | 50 | 50 | 50 |
| compound of Formula (2) | Formula (2-1) | 10 | | | |
| | Formula (2-2) | | | | |
| | Formula (2-3) | | | | |
| | Formula (2-4) | | | | |
| | Formula (2-5) | | | | |
| | Formula (2-6) | | | | |
| compound of Formula (3) to Formula | Formula (3-1) | | | | |
| (5) | Formula (3-2) | | | | |
| | Formula (4-1) | | | | |
| | Formula (4-2) | | | | |
| | Formula (5-1) | | | | |
| polyolefin | G1726 | | | | |
| | B-3000 | | | | |
| | polyfunctional vinyl | | | | |
| | aromatic copolymer | | | | |
| unsaturated C═C double | DVB | | | | |
| bond-containing crosslinking agent | BVPE | | | | |
| | TAIC | | | | |
| maleimide resin different from | BMI-1 | | | | |
| compound of Formula (1) | BMI-2 | 50 | | | |
| curing accelerator different from | 25B | | 10 | | |
| compound of Formula (2) | DCP | | | 10 | |
| | 2E4MZ | | | | 10 |
| inorganic filler | SC-2500-SVJ | 150 | 150 | 150 | 150 |
| solvent | toluene:MEK = 3:7 | PA | PA | PA | PA |

| Item | Unit | C6 | C7 | C8 | C9 |
|---|---|---|---|---|---|
| tanδ | none | 0.08 | 0.08 | 0.08 | 0.09 |
| Z-PTE | % | 1.6 | 1.8 | 2.0 | 2.5 |
| TcDk | ppm/° C. | 19.2 | 50.2 | 51.8 | 51.1 |
| TcDf | ppm/° C. | 4015 | 5459 | 5568 | 5487 |
| radial filling capacity value of prepreg | % | 75 | 70 | 70 | 70 |
| solder dip delamination rate of | % | 15 | 10 | 10 | 20 |
| multi-layer board | | | | | |
| PIM | dBc | −149.5 | −145.1 | −143.2 | −144.3 |

According to the present disclosure, for the property tests of Examples and Comparative Examples, samples (specimens) were prepared as described below and tested under specified conditions.
(1) Prepreg (PP): Resin composition from each Example or each Comparative Example was individually well-mixed to form a varnish, which was then loaded to an impregnation tank; a fiberglass fabric (e.g., 2116 or 1080 L-glass fiber fabric, all available from Asahi) was impregnated into the impregnation tank to adhere the resin composition onto the fiberglass fabric, followed by heating at 150° C. to 170° C. to the B-stage to obtain a prepreg. Prepregs made from the 1080 L-glass fiber fabrics have a resin content of about 70%, and prepregs made from the 2116 L-glass fiber fabrics have a resin content of about 55%.
(2) Copper-clad laminate (8-ply, formed by lamination of eight prepregs): Two 18 μm hyper very low profile (HVLP) copper foils and eight prepregs obtained from 2116 L-glass fiber fabrics impregnated with each Example or Comparative Example were prepared, each prepreg having a resin content of about 55%. An HVLP copper foil, eight prepregs and an HVLP copper foil were superimposed in such order and then subjected to a vacuum condition for lamination at 420 psi and 200° C. for 2 hours to form each copper-clad laminate sample.
(3) Copper-clad laminate (12-ply, formed by lamination of twelve prepregs): Two 18 μm hyper very low profile (HVLP) copper foils and twelve prepregs obtained from 1080 L-glass fiber fabrics impregnated with each Example or Comparative Example were prepared, each prepreg having a resin content of about 70%. An HVLP copper foil, twelve prepregs and an HVLP copper foil were superimposed in such order and then subjected to a vacuum condition for lamination at 420 psi and 200° C. for 2 hours to form each copper-clad laminate sample.
(4) Copper-free laminate (8-ply, formed by lamination of eight prepregs): Each aforesaid copper-clad laminate (8-ply) was etched to remove the copper foils on both sides to obtain a copper-free laminate (8-ply).
(5) Copper-free laminate (2-ply, formed by lamination of two prepregs): Two 18 μm hyper very low profile (HVLP) copper foils and two prepregs obtained from 1080 L-glass fiber fabrics impregnated with each Example or Comparative Example were prepared and stacked in the order of one copper foil, two prepregs and one copper foil, followed by lamination under vacuum at 420 psi and 200° C. for 2 hours to form a copper-clad laminate (2-ply, formed by lamination of two prepregs). Then each copper-clad laminate (2-ply) obtained above was etched for removing the two copper foils so as to obtain the copper-free laminate.

For each sample, test items and test methods are described below.

### 1. Ratio of Loss Modulus to Storage Modulus (tan δ)

The copper-free laminate (8-ply) sample was subjected to the measurement. A dynamic mechanical analyzer (DMA) was used by reference to IPC-TM-650 2.4.24.4 to measure the glass transition temperature, the loss modulus and the storage modulus of each sample, and the ratio of loss modulus to storage modulus at the glass transition temperature is the tan δ. Temperature interval during the measurement was set at 50° C. to 400° C. with a temperature increase rate of 2° C./minute; lower tan δ represents better rigidity of the sample.

### 2. Percent of Thermal Expansion in Z-Axis (Z-PTE)

The copper-free laminate (8-ply) sample was subjected to thermal mechanical analysis (TMA) by reference to IPC-TM-650 2.4.24.5. Each sample was heated from 50° C. to 260° C. at a heating rate of 10° C./minute and then subjected to the measurement of percent (%) of thermal expansion in Z-axis in a temperature range of 50° C. to 260° C. When the percent of thermal expansion in Z-axis is less than or equal to 1%, a difference in the percent of thermal expansion in Z-axis of greater than or equal to 2% represents a substantial difference (i.e., significant technical difficulty) in different samples.

### 3. Temperature Coefficient of Dielectric Constant (TcDk)

The copper-free laminate (2-ply) was cut into a 8 cm*8 cm square specimen, which was tested by using a SPDR split post dielectric resonant cavity (available from

Waveray) by reference to IPC-TM-650 2.5.5.13 at 10 GHz and 65% relative humidity to measure the change in dielectric constant (Dk) of the sample in a temperature range of 25° C. to 150° C. Lower temperature coefficient of dielectric constant (TcDk) represents less change in the dielectric constant during temperature increase, which represents a more stable dielectric constant of the insulation layers of the copper-free laminate, such that a printed circuit board made therefrom may achieve more stable signal transmission at high temperature.

### 4. Temperature Coefficient of Dissipation Factor (TcDf)

The copper-free laminate (2-ply) was cut into a 8 cm*8 cm square specimen, which was tested by using a SPDR split post dielectric resonant cavity (available from Waveray) by reference to IPC-TM-650 2.5.5.13 at 10 GHz and 65% relative humidity to measure the change in dissipation factor (Df) of the sample in a temperature range of 25° C. to 150° C. Lower temperature coefficient of dissipation factor (TcDf) represents less change in the dissipation factor during temperature increase, which represents a more stable dissipation factor of the insulation layers of the copper-free laminate, such that a printed circuit board made therefrom may achieve higher signal integrity at high temperature.

### 5. Solder Dip Delamination Rate of Multi-Layer Board

A prepreg (resin content of about 55%) prepared from a 2116 L-glass fiber fabric impregnated with each Example or each Comparative Example was superimposed on both sides with a piece of hyper very low profile copper foil (18 μm in thickness), followed by lamination and curing under vacuum at high temperature (200° C.) and high pressure (500 psi) for 2 hours to obtain a copper-clad core. Then the copper-clad core obtained above was etched to remove the copper foils on both sides so as to obtain a copper-free core (5 mil in thickness). Three copper-free cores were prepared as above. Next, two 18 μm HVLP copper foils and eight prepregs (resin content of about 70%) obtained from 1080 L-glass fiber fabrics impregnated with each Example or Comparative Example were prepared and stacked in the order of one copper foil, two prepregs (obtained from 1080 L-glass fiber fabrics), one copper-free core, two prepregs (obtained from 1080 L-glass fiber fabrics), one copper-free core, two prepregs (obtained from 1080 L-glass fiber fabrics), one copper-free core, two prepregs (obtained from 1080 L-glass fiber fabrics), and one copper foil, followed by lamination under vacuum at 500 psi and 200° C. for 2 hours to form an eight-layer copper-clad laminate, which was then cut to form a 18 inch*16 inch rectangular sample. The rectangular sample was subjected to a circuit board drilling process to make a 20*25 array of through holes (500 through holes) with a diameter of 0.3 mm, the vertical distance of adjacent hole walls being in six designs including 0.25/0.3/0.35/0.4/0.5/0.7 mm, six designs being a group, and a total of 24 groups being on the entire board, i.e., a total of 72,000 through holes. Then the hole walls were copper-plated, and twenty samples were picked from the edge of the board or in the board.

By reference to IPC-TM-650 2.4.13.1, each aforesaid sample for multi-layer board heat resistance test was horizontally placed on (i.e., in contact with) the solder bath of a 288° C. solder pot; during each test, one surface of the sample was placed on the solder bath for 10 seconds and then removed therefrom and cooled at room temperature for 30 seconds, which was recorded as one round, and the sample was subjected to 10 rounds of test without overturning. The sample after 10 rounds of solder floating was sectioned at the drilled area and observed with an optical microscope to determine the presence or absence of delamination. The ratio of samples with delamination to the total samples was calculated as the delamination rate. As used herein, delamination may refer to interlayer separation or blistering. Delamination may occur between any layers of a laminate. For example, interlayer separation between insulation layers is considered as delamination; for example, blistering or separation between a copper foil and an insulation layer is also considered as delamination.

### 6. Passive Intermodulation (PIM)

The aforesaid copper-clad laminate (12-ply) was chosen to make the PIM sample, and the passive intermodulation (in dBc) of the sample at 1900 MHz was measured by reference to IEC-62037.

### 7. Radial Filling Capacity Value of Prepreg

The aforesaid copper-clad laminate (8-ply) sample was drilled according to the data shown in the table below, and the prepreg (obtained from 1080 L-glass fiber fabric) was placed on the drilled copper-clad laminate, which was then subjected to a vacuum condition for lamination at 420 psi and 200° C. for two hours to form a lamination test board. The test board was cut open, and the total number of holes on the cross-section and the number of holes filled with resin were counted, such that the radial filling capacity value of prepreg can be calculated as: (number of holes filled with resin/total number of holes) *100%, which represents the flowability of the prepreg and the hole filling capacity.

| hole size (mm) | 0.20 | 0.40 | 0.50 | 0.65 | 0.75 | 0.90 | 1.00 | 1.25 | total |
|---|---|---|---|---|---|---|---|---|---|
| number | 37074 | 168 | 7668 | 168 | 168 | 168 | 168 | 168 | 45750 |

The following observations can be made from the test results in Table 1 to Table

6.

From Examples E1 to E20, it can be confirmed that the resin composition of the present disclosure and the article made therefrom can improve one or more properties including ratio of loss modulus to storage modulus, percent of thermal expansion in Z-axis, temperature coefficient of dielectric constant, temperature coefficient of dissipation factor, radial filling capacity value of prepreg and passive intermodulation. The resin composition of each of Examples E1 to E10 does not contain the

compounds of Formula (3) to Formula (5), while the resin composition of each of Examples E11 to E20 contains at least one of the compounds of Formula (3) to Formula (5). The resin composition containing at least one of the compounds of Formula (3) to Formula (5) and the article made therefrom, in contrast to the resin composition not containing the compounds of Formula (3) to Formula (5) and the article made therefrom, significantly improves at least three properties including temperature coefficient of dielectric constant, temperature coefficient of dissipation factor and radial filling capacity value of prepreg.

The compound of Formula (2) used in Examples E8 to E10, E19 and E20 has an unsaturated C═C double bond-containing group, while the compound of Formula (2) used in Examples E1 to E7 and E11 to E18 does not have an unsaturated C═C double bond-containing group. The resin composition using the compound of Formula (2) having an unsaturated C═C double bond-containing group and the article made therefrom, in contrast to the resin composition using the compound of Formula (2) without an unsaturated C═C double bond-containing group and the article made therefrom, significantly improves at least the ratio of loss modulus to storage modulus.

From the comparison of Examples E1 to E20 with Comparative Examples C1 to C2, it can be found that, relative to 100 parts by weight of the unsaturated C═C double bond-containing polyphenylene ether resin, if the amount of the compound of Formula (1) is not within the range of 10 to 80 parts by weight, the corresponding resin composition and the article made therefrom will have serious deterioration in at least two properties including the solder dip delamination rate of multi-layer board and the passive intermodulation.

From the comparison of Examples E1 to E20 with Comparative Examples C3 to C4, it can be found that, relative to 100 parts by weight of the unsaturated C═C double bond-containing polyphenylene ether resin, if the amount of the compound of Formula (2) is not within the range of 1 to 20 parts by weight, the corresponding resin composition and the article made therefrom will have serious deterioration in at least three properties including the ratio of loss modulus to storage modulus, the solder dip delamination rate of multi-layer board and the passive intermodulation.

From the comparison of Examples E1 to E20 with Comparative Examples C5 to C6, it can be found that, by using the compound of Formula (1), in contrast to using other maleimide resins, the resin composition and the article made therefrom can significantly improve at least four properties including the ratio of loss modulus to storage modulus, the percent of thermal expansion in Z-axis, the temperature coefficient of dissipation factor and the passive intermodulation.

From the comparison of Examples E1 to E20 with Comparative Examples C7 to C9, it can be found that, by using the compound of Formula (2), in contrast to using other curing accelerators, the resin composition and the article made therefrom can significantly improve several properties including the ratio of loss modulus to storage modulus, the percent of thermal expansion in Z-axis, the temperature coefficient of dielectric constant, the temperature coefficient of dissipation factor and the passive intermodulation.

The above detailed description is merely illustrative in nature and is not intended to limit the embodiments of the subject matter or the applications and uses of such embodiments. As used herein, the term “exemplary” or similar expression means “serving as an example, instance, or illustration.” Any implementation described herein as exemplary is not necessarily to be construed as preferred or advantageous over other implementations, unless otherwise specified.

Moreover, while at least one exemplary example or comparative example has been presented in the foregoing detailed description, it should be appreciated that a vast number of variations exist. It should also be appreciated that the exemplary one or more embodiments described herein are not intended to limit the scope, applicability, or configuration of the claimed subject matter in any way. Rather, the foregoing detailed description will provide those skilled in the art with a convenient guide for implementing the described one or more embodiments and equivalents thereof. Also, the scope defined by the claims includes known equivalents and foreseeable equivalents at the time of filing this patent application.

What is claimed is:

1. A resin composition, comprising:
(A) 100 parts by weight of an unsaturated C═C double bond-containing polyphenylene ether resin;
(B) 10 parts by weight to 80 parts by weight of a compound of Formula (1); and
(C) 1 part by weight to 20 parts by weight of a compound of Formula (2); 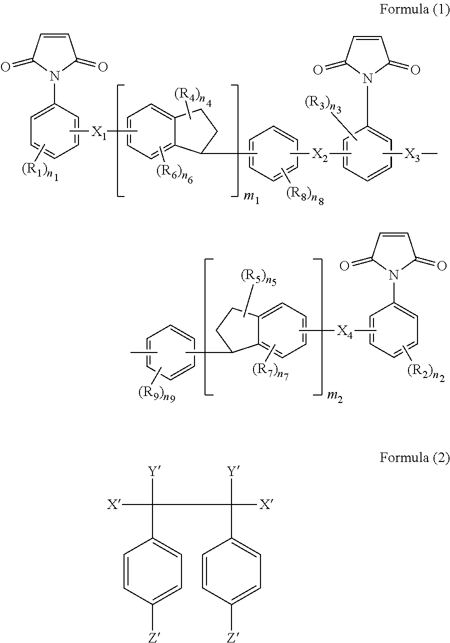
wherein:
in Formula (1), R₁ to R₉ each independently represent a C1 to C4 alkyl group; n1, n2, n8 and no each independently represent an integer of 0 to 4; n4 and n5 each independently represent an integer of 0 to 5; n₃, n₆ and n₇ each independently represent an integer of 0 to 3; m1 and m2 each independently represent average number of repeating units, m₁ is a value of 0 to 20, m₂ is a value of 0 to 20, and m₁+m₂=0.5 to 20; and X₁, X₂, X₃ and X₄ each independently represent a C1 to C4 divalent alkyl group; and
in Formula (2), each X′, Y′ and Z′ independently represent a C1 to C4 alkyl group, a phenyl group, a hydrogen atom or an unsaturated C═C double bond-containing group.

2. The resin composition of claim 1, wherein the unsaturated C═C double bond-containing polyphenylene ether resin comprises any one of a vinylbenzyl group-containing polyphenylene ether resin, a (meth)acryloyl group-containing polyphenylene ether resin and a vinyl group-containing polyphenylene ether resin or a combination thereof.

3. The resin composition of claim 1, wherein the compound of Formula (1) comprises a compound of Formula (1-1): 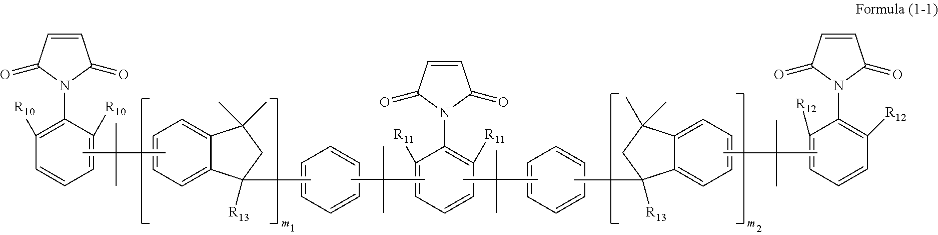
wherein, R₁₀, R₁₁, R₁₂ and R₁₃ each independently represent a hydrogen atom or a C1 to C4 alkyl group, m1 and m2 each independently represent average number of repeating units, m1 is a value from 0 to 20, m₂ is a value from 0 to 20, and m₁+m₂=0.5 to 20.

4. The resin composition of claim 1, wherein the compound of Formula (1) comprises any one of a compound of Formula (1-2), a compound of Formula (1-3), a compound of Formula (1-4), a compound of Formula (1-5), a compound of Formula (1-6), a compound of Formula (1-7) and a compound of Formula (1-8) or a combination thereof: 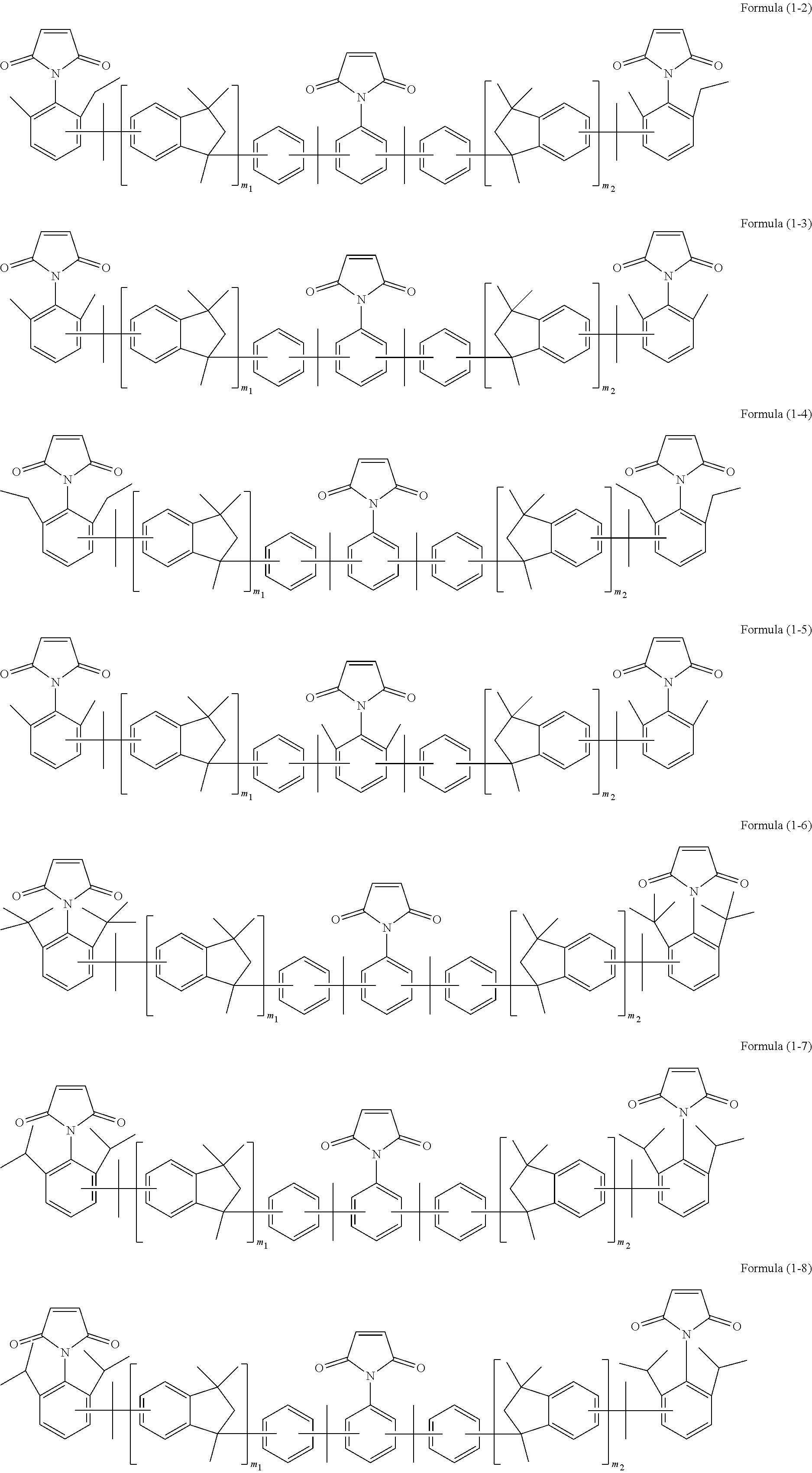
in Formula (1-2) to Formula (1-8), m₁ and m₂ each independently represent average number of repeating units, m₁ is a value from 0 to 20, m₂ is a value from 0 to 20, and m₁+m₂=0.5 to 20.

5. The resin composition of claim 1, wherein the compound of Formula (2) has at least one unsaturated C═C double bond-containing group.

6. The resin composition of claim 1, wherein the compound of Formula (2) comprises any one of a compound of Formula (2-1), a compound of Formula (2-2), a compound of Formula (2-3), a compound of Formula (2-4), a compound of Formula (2-5) and a compound of Formula (2-6) or a combination thereof:

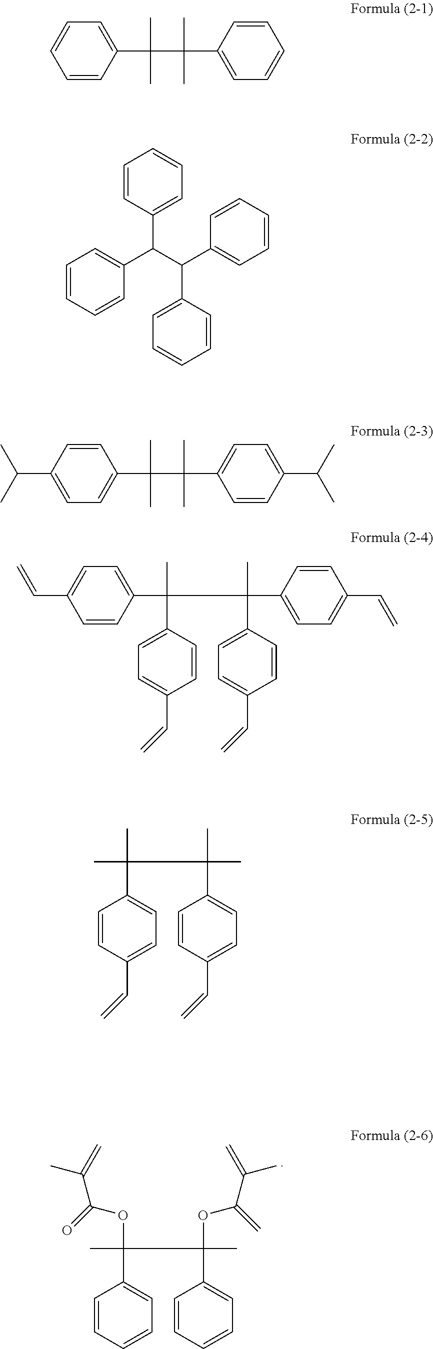

7. The resin composition of claim 1, further comprising 0.001 part by weight to 0.8 part by weight of any one of a compound of Formula (3), a compound of Formula (4) and a 5 compound of Formula (5) or a combination thereof: 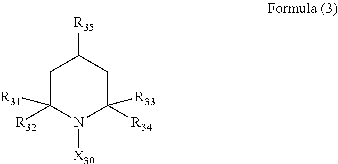
in Formula (3), X₃₀ is an oxygen radical or a hydroxyl group; R₃₁ to R₃₄ are independently a hydrogen atom or a C1 to C4 alkyl group, and R₃₁ to R₃₄ are not a hydrogen atom at the same time; and R₃₅ is a hydrogen atom, a methyl group, an amino group, a hydroxyl group, a carbonyl group or a carboxyl group; 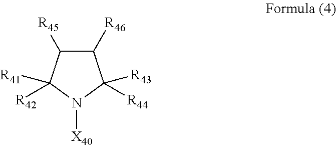
in Formula (4), X₄₀ is an oxygen radical or a hydroxyl group; R₄₁ to R₄₄ are independently a hydrogen atom or a C1 to C4 alkyl group, and R₄₁ to R₄₄ are not a hydrogen atom at the same time; R₄₅ and R₄₆ are independently a hydrogen atom, a methyl group, an amino group, a hydroxyl group, a carbonyl group or a carboxyl group, or R₄₅ and R₄₆ together define a benzene ring structure; 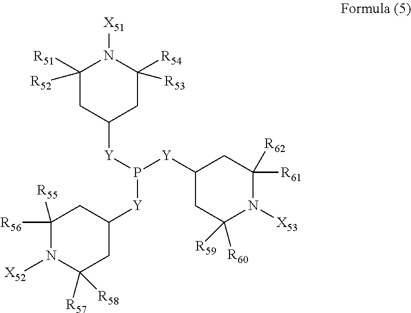
in Formula (5), P is a phosphorus atom, X₅₁ to X₅₃ each independently is an oxygen radical or a hydroxyl group; Y is an oxygen atom or a phenylene group; R₅₁ to R₆₂ are independently a hydrogen atom or a C1 to C4 alkyl group, and R₅₁ to R₆₂ are not a hydrogen atom at the same time.

8. The resin composition of claim 7, wherein the compound of Formula (3) comprises any one of a compound of Formula (3-1), a compound of Formula (3-2), a compound of Formula (3-3), a compound of Formula (3-4) and a compound of Formula (3-5) or a combination thereof, the compound of Formula (4) comprises any one of a compound of Formula (4-1), a compound of Formula (4-2), a compound of Formula (4-3) and a 10 compound of Formula (4-4) or a combination thereof, and the compound of Formula (5) comprises any one of a compound of Formula (5-1), a compound of Formula (5-2) and a compound of Formula (5-3) or a combination thereof:

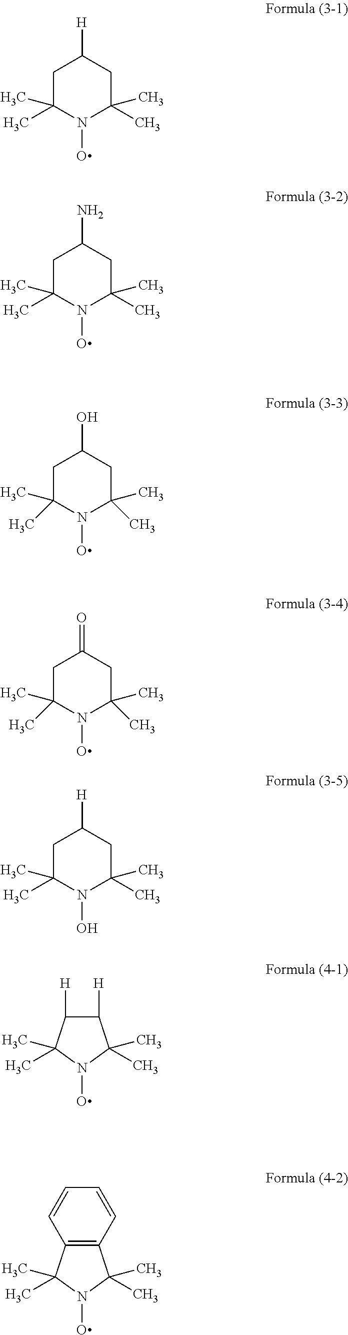

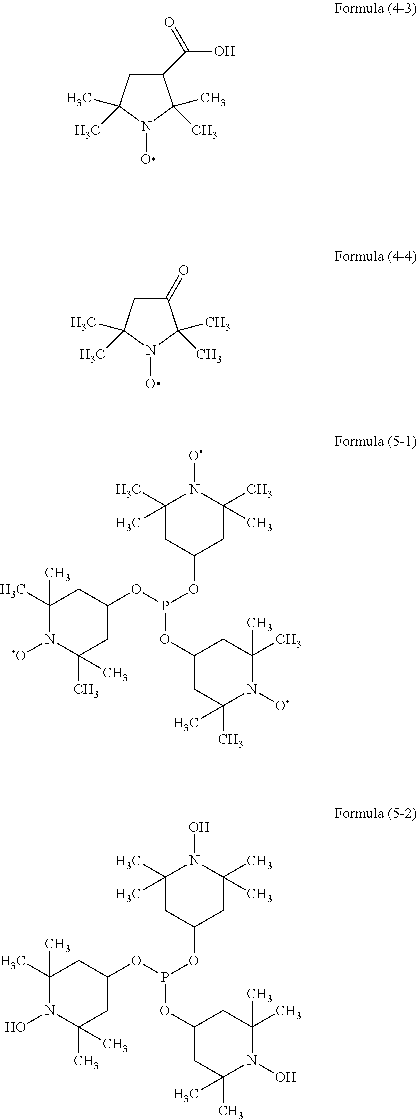

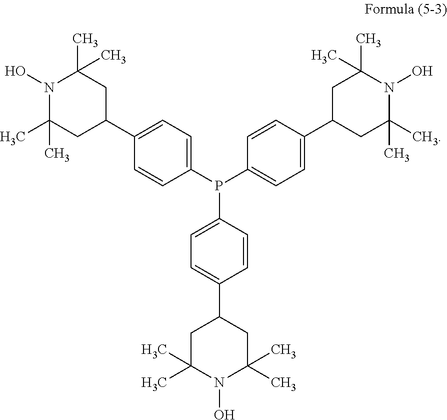 [SMILES: CC1(C)CC(c2ccc(P(c3ccc(C4CC(C)(C)N(O)C(C)(C)C4)cc3)c3ccc(C4CC(C)(C)N(O)C(C)(C)C4)cc3)cc2)CC(C)(C)N1O]

9. The resin composition of claim 1, further comprising 5 parts by weight to 25 parts by weight of an unsaturated C═C double bond-containing crosslinking agent, 20 parts by weight to 80 parts by weight of a polyolefin or a combination thereof.

10. The resin composition of claim 1, further comprising any one of a benzoxazine resin, an epoxy resin, a polyester resin, a phenol resin, an amine curing agent, a polyamide, a polyimide, a styrene maleic anhydride, a maleimide resin different from the compound of Formula (1), a cyanate ester and a maleimide triazine resin or a combination thereof.

11. The resin composition of claim 1, further comprising any one of an inorganic filler, a flame retardant, a curing accelerator different from the compound of Formula (2), a solvent, a silane coupling agent, a coloring agent and a toughening agent or a combination thereof.

12. An article made from the resin composition of claim 1, comprising a prepreg, a resin film, a laminate or a printed circuit board.

13. The article of claim 12, having a ratio of loss modulus to storage modulus as measured by reference to IPC-TM-650 2.4.24.4 of less than or equal to 0.07.

14. The article of claim 12, having a percent of thermal expansion in Z-axis as measured by reference to IPC-TM-650 2.4.24.5 of less than or equal to 1.5%.

15. The article of claim 12, having a temperature coefficient of dielectric constant as measured by reference to IPC-TM-650 2.5.5.13 of less than or equal to 12.0 ppm/° C.

16. The article of claim 12, having a temperature coefficient of dissipation factor as measured by reference to IPC-TM-650 2.5.5.13 of less than or equal to 3400 ppm/° C.

17. The article of claim 12, having a passive intermodulation as measured by reference to IEC-62037 of less than or equal to-162.0 dBc.
